(19) United States
(12) Patent Application Publication
(10) Pub. No.: US 2026/0249748 A1
(43) Pub. Date: Aug. 27, 2026

(54) Seat Bracket and Seat

(71) Applicant: DewertOkin Technology Group Co., Ltd., Jiaxing (CN)

(72) Inventors: Qiqi YE, Jiaxing (CN); Liming YANG, Jiaxing (CN); Yingjun CHAI, Jiaxing (CN)

(21) Appl. No.: 19/541,244

(22) Filed: Feb. 16, 2026

(30) Foreign Application Priority Data
Feb. 21, 2025 (CN) 202510197957.8
Feb. 21, 2025 (CN) 202520293912.6
Jan. 27, 2026 (CN) 202620115959.8

(51) Int. Cl. B60N 2/06; B60N 2/20; B60N 2/30

(52) U.S. Cl. CPC B60N 2/06; B60N 2/20; B60N 2/3013

(57) ABSTRACT

The present disclosure provides a seat bracket and a seat, wherein the seat bracket includes: a chassis, including a base and a side plate swingably arranged on the base; a seat frame, swingably arranged on the side plate and having a sitting posture, a TV posture and a zero gravity posture, the seat frame including a swingable seat frame plate; a linkage mechanism, including a first linkage plate and a second linkage plate disposed at intervals, two ends of the first linkage plate being respectively hinged to the side plate and the seat frame plate, two ends of the second linkage plate being respectively hinged to the side plate and the seat frame plate, and the side plate, the first linkage plate, the second linkage plate and the seat frame plate at least enclosing a closed four-linkage structure; and a first driving member, arranged on the base.

### CROSS-REFERENCE TO RELATED APPLICATION

The present application claims the priority of the following application documents submitted to the China National Intellectual Property Administration:
1. Chinese patent application No. 202510197957.8, entitled "Seat Bracket and Seat" filed on Feb. 21, 2025;
2. Chinese patent application No. 202520293912.6, entitled "Seat Bracket and Seat" filed on Feb. 21, 2025; and
3. Chinese patent application No. 202620115959.8, entitled "Seat Bracket and Seat" filed on Jan. 27, 2026.

The full texts of the three Chinese patent applications mentioned above are hereby incorporated by reference in their entirety.

### TECHNICAL FIELD

The present disclosure relates to the field of movable furniture, specifically to a seat bracket and a seat.

### BACKGROUND

With the continuous improvement of living standards, users have a relatively high pursuit for the comfort of seats. One type of seat has a lifting function, such as a hoisting seat, a lifting seat or a seat for the elderly. A seat bracket in related technologies includes: a base and a seat frame swingably hinged to the base. The seat frame has a sitting posture, a TV posture and a zero gravity posture. When the seat frame is in the sitting posture, a backrest frame of the seat frame is almost upright, and a footrest mechanism of the seat frame is folded. When the seat frame is in the TV posture, the backrest frame of the seat frame is almost upright, and the footrest mechanism of the seat frame extends forward. When the seat frame is in the zero gravity posture, the backrest frame of the seat frame tilts backward, and the footrest mechanism of the seat frame remains extended forward.

In a process of switching the seat frame among the sitting posture, the TV posture and the zero gravity posture, the gravity of the seat bracket is concentrated at the hinge position between the seat frame and the base, which may easily cause lagging during a switching process of the seat frame, leading to poor user comfort experience.

### SUMMARY

The main purpose of the present disclosure is to provide a seat bracket and a seat, so as to solve the problem of lagging during a switching process of the seat frame in related technologies, leading to poor user comfort experience.

In order to achieve the above purpose, according to one aspect of the present disclosure, a seat bracket is provided. The seat bracket includes: a chassis, including a base and a side plate swingably arranged on the base; a seat frame, swingably arranged on the side plate and having a sitting posture, a TV posture and a zero gravity posture, the seat frame including a swingable seat frame plate; a linkage mechanism, including a first linkage plate and a second linkage plate disposed at intervals, two ends of the first linkage plate being respectively hinged to the side plate and the seat frame plate, two ends of the second linkage plate being respectively hinged to the side plate and the seat frame plate, and the side plate, the first linkage plate, the second linkage plate and the seat frame plate at least enclosing a closed four-linkage structure; and a first driving member, arranged on the base, when or after the first driving member operates, the seat frame plate swinging to drive the first linkage plate and the second linkage plate to swing to deform the four-linkage structure so that the seat frame is switched among the sitting posture, the TV posture and the zero gravity posture, wherein in a process of switching the seat frame from the sitting posture or the TV posture to the zero gravity posture, the seat frame plate takes a zero gravity line as a reference line, the front end of the seat frame plate is adjusted to move towards the reference line, and the rear end of the seat frame plate is adjusted to move towards the reference line.

According to another aspect of the present disclosure, a seat is provided. The seat includes a seat bracket. The seat bracket is the seat bracket mentioned above.

According to still another aspect of the present disclosure, a seat is provided. The seat includes a seat bracket, a backrest soft cushion, a seat soft cushion and a leg soft cushion. The seat bracket is the seat bracket mentioned above, the seat bracket further includes a footrest mechanism, the backrest soft cushion is mounted on a backrest frame, the seat soft cushion is mounted on a seat frame plate, and the leg soft cushion is mounted on the footrest mechanism.

Applying the technical solution of the present disclosure, the seat bracket includes: a chassis, a seat frame, a linkage mechanism and a first driving member. The chassis includes a base and a side plate swingably arranged on the base. The seat frame is swingably arranged on the side plate and has a sitting posture, a TV posture and a zero gravity posture, and the seat frame includes a swingable seat frame plate. The linkage mechanism includes a first linkage plate and a second linkage plate disposed at intervals, two ends of the first linkage plate are respectively hinged to the side plate and the seat frame plate, two ends of the second linkage plate are respectively hinged to the side plate and the seat frame plate, and the side plate, the first linkage plate, the second linkage plate and the seat frame plate at least enclose a closed four-linkage structure. The first driving member is arranged on the base, and when or after the first driving member is driven to operate, the seat frame plate swings to drive the first linkage plate and the second linkage plate to swing to deform the four-linkage structure so that the seat frame is switched among the sitting posture, the TV posture and the zero gravity posture. In a process of switching the seat frame from the sitting posture or the TV posture to the zero gravity posture, the seat frame plate takes a zero gravity line as a reference line, the front end of the seat frame plate is adjusted to move towards the reference line, and the rear end of the seat frame plate is adjusted to move towards the reference line. According to the design of at least enclosing the closed four-linkage structure by the side plate, the first linkage plate, the second linkage plate and the seat frame plate, it is ensured that the first linkage plate and the second linkage plate can swing synchronously. In addition, the four-linkage structure relatively evenly bears forces simultaneously and disperses the forces, resulting in balanced force distribution during the entire process of switching the seat frame to the zero gravity posture, thereby preventing the gravity of the seat bracket from being concentrated at one hinge position, such as the hinge position between the first linkage plate and the side plate, or the hinge position between the second linkage plate and the side plate. The zero gravity line (the heart and knees of a user are close to the same horizontal line) is used as the reference line, and the front end of the seat frame plate and the rear end of the seat frame plate can be adjusted simultaneously and smoothly, so as to achieve the linear movement of the seat frame plate, thereby avoiding the phenomenon of lagging caused by force concentration. The coordination optimization can ensure that in a process of switching from the sitting posture or the TV posture to the zero gravity posture, the front end and rear end of the seat frame plate can be adjusted simultaneously and smoothly, and the zero gravity line is used as the reference line to achieve the linear movement of the seat frame plate, so that the force is evenly applied to each part of the body of the user without the sense of pressure, thereby improving the comfort experience of the user. Therefore, the technical solution of the present disclosure effectively solves the problem of lagging during a switching process of the seat frame in related technologies, leading to poor user comfort experience.

### BRIEF DESCRIPTION OF THE DRAWINGS

The accompanying drawings of the specification, constituting a part of the present disclosure, are used to provide a further understanding of the present disclosure. The exemplary embodiments of the present disclosure and the descriptions thereof are intended to explain the present disclosure, but do not constitute an improper limitation on the present disclosure. In the accompanying drawings:

FIG. 1 shows a schematic view of a three-dimensional structure when a seat frame according to an embodiment of a seat bracket of the present disclosure is in a sitting posture;

FIG. 2 shows a schematic view of a three-dimensional structure when the seat frame of the seat bracket in FIG. 1 is in a TV posture;

FIG. 3 shows a schematic front view when the seat frame of the seat bracket in FIG. 2 is in a TV posture;

FIG. 4 shows a schematic view of a three-dimensional structure when the seat frame of the seat bracket in FIG. 1 is in a zero gravity posture, wherein this figure shows partial structures of a seat frame plate, a linkage mechanism and a footrest mechanism;

FIG. 5 shows a schematic front view when the seat frame of the seat bracket in FIG. 4 is in a zero gravity posture;

FIG. 6 shows a schematic view of a three-dimensional structure when the seat frame of the seat bracket in FIG. 1 is in a standing posture;

FIG. 7 shows a schematic view of a partial structure from another perspective when the seat frame of the seat bracket in FIG. 1 is in a standing posture;

FIG. 8 shows a schematic view of a three-dimensional structure when the seat frame of the seat bracket in FIG. 1 in a sitting posture is in a lifting posture;

FIG. 9 shows a schematic view of a three-dimensional structure when the seat frame of the seat bracket in FIG. 1 in a TV posture is in a lifting posture;

FIG. 10 shows a schematic view of a three-dimensional structure when a seat frame according to another embodiment of a seat bracket of the present disclosure is in a sitting posture, wherein this figure shows partial structures of a seat frame plate, a linkage mechanism and a footrest mechanism;

FIG. 11 shows a schematic view of a three-dimensional structure when the seat frame of the seat bracket in FIG. 10 is in a TV posture, wherein this figure shows partial structures of a seat frame plate, a linkage mechanism and a footrest mechanism;

FIG. 12 shows a schematic view of a three-dimensional structure when the seat frame of the seat bracket in FIG. 10 is in a zero gravity posture, wherein this figure shows partial structures of a seat frame plate, a linkage mechanism and a footrest mechanism;

FIG. 13 shows a schematic view of principle when a backrest frame of a seat bracket in a related technology is switched from a sitting posture to a lying posture;

FIG. 14 shows a schematic view of a three-dimensional structure when a seat frame according to still another embodiment of a seat bracket of the present disclosure is in a TV posture, wherein only one linkage mechanism, one footrest mechanism and part of the seat frame are shown;

FIG. 15 shows a schematic view of a three-dimensional structure from another perspective when the seat frame of the seat bracket in FIG. 14 is in a TV posture;

FIG. 16 shows a schematic view of a three-dimensional structure when a seat frame according to yet another embodiment of a seat bracket of the present disclosure is in a zero gravity posture, wherein only one linkage mechanism, one footrest mechanism and part of the seat frame are shown;

FIG. 17 shows a schematic view of a three-dimensional structure when a seat frame according to still yet another embodiment of a seat bracket of the present disclosure is in a sitting posture, wherein only one linkage mechanism, one footrest mechanism and part of the seat frame are shown;

FIG. 18 shows a schematic view of a three-dimensional structure when a seat frame according to a further embodiment of a seat bracket of the present disclosure is in a standing posture, wherein only one linkage mechanism, one footrest mechanism and part of the seat frame are shown;

FIG. 19 shows a schematic view of a three-dimensional structure from another perspective when the seat frame of the seat bracket in FIG. 18 is in a standing posture;

FIG. 20 shows a schematic view of a three-dimensional structure when a seat frame according to a still further embodiment of a seat bracket of the present disclosure is in a lying posture, wherein only one linkage mechanism, one footrest mechanism and part of the seat frame are shown; and

FIG. 21 shows a schematic view of principle when a backrest frame according to a yet further embodiment of a seat bracket of the present disclosure is switched from a sitting posture to a lying posture.

The above accompanying drawings have the following reference numerals:

10. chassis; 11. base; 111. support protrusion; 12. side plate; 121. first plate body; 122. second plate body; 13. first support plate; 14. second support plate; 15. rear transverse rod; 16. front transverse rod;

20. seat frame; 21. seat frame plate; 22. driving plate; 23. first driven plate; 24. second driven plate; 25. backrest frame; 26. follow-up plate; 27. transmission plate; 271. transmission plate body;

30. linkage mechanism; 31. first linkage plate; 32. second linkage plate; 33. third linkage plate; 34. lifting plate;

41. first driving member; 411. telescopic rod; 412. driving rod; 42. second driving member; 421. second moving structure; 422. second driving rod; 43. third driving member; 431. first moving structure; 432. first driving rod; 433. end connection plate;

L1. first preset distance; L2. second preset distance;

50. footrest mechanism; 51. pedal; 52. first front connection plate; 53. second front connection plate; 54. first rear connection plate; 55. second rear connection plate;

61. limiting member; 62. first limiting part; 63. second limiting part;

71. damping member;

D1. hinge point 1; D2. hinge point 2; D3. hinge point 3; D4. hinge point 4.

### DETAILED DESCRIPTION OF THE EMBODIMENTS

The technical solutions in the embodiments of the present disclosure are clearly and completely described below with reference to the accompanying drawings in the embodiments of the present disclosure. It is apparent that the described embodiments are only a part of the embodiments of the present disclosure, rather than all of the embodiments. The following descriptions of at least one exemplary embodiment are merely illustrative actually, and should not be construed as any limitation on the present disclosure and the disclosure or use thereof. All other embodiments obtained by those of ordinary skill in the art based on the embodiments in the present disclosure without creative efforts shall fall within the scope of protection of the present disclosure.

The present disclosure provides a seat bracket. An embodiment of the seat bracket includes: a chassis 10, a seat frame 20, a linkage mechanism 30 and a first driving member 41. The chassis 10 includes a base 11 and a side plate 12 swingably arranged on the base 11. The seat frame 20 is swingably arranged on the side plate 12 and has a sitting posture, a TV posture and a zero gravity posture, and the seat frame 20 includes a swingable seat frame plate 21. The linkage mechanism 30 includes a first linkage plate 31 and a second linkage plate 32 disposed at intervals, two ends of the first linkage plate 31 are respectively hinged to the side plate 12 and the seat frame plate 21, two ends of the second linkage plate 32 are respectively hinged to the side plate 12 and the seat frame plate 21, and the side plate 12, the first linkage plate 31, the second linkage plate 32 and the seat frame plate 21 enclose a closed four-linkage structure. The first driving member 41 is arranged on the base 11, and when or after the first driving member 41 operates, the seat frame plate 21 swings to drive the first linkage plate 31 and the second linkage plate 32 to swing to deform the four-linkage structure so that the seat frame 20 is switched among the sitting posture, the TV posture and the zero gravity posture. In a process of switching the seat frame 20 from the sitting posture or the TV posture to the zero gravity posture, the seat frame plate 21 takes a zero gravity line as a reference line, the front end of the seat frame plate 21 is adjusted to move towards the reference line, and the rear end of the seat frame plate 21 is adjusted to move towards the reference line.

According to the technical solution of one embodiment of the seat bracket, the side plate 12, the first linkage plate 31, the second linkage plate 32 and the seat frame plate 21 enclose a closed four-linkage structure. In a process of switching the seat frame 20 from the sitting posture or the TV posture to the zero gravity posture, the seat frame plate 21 takes a zero gravity line as a reference line, the front end of the seat frame plate 21 is adjusted to move towards the reference line, and the rear end of the seat frame plate 21 is adjusted to move towards the reference line. According to the design of the four-linkage structure, it is ensured that the first linkage plate 31 and the second linkage plate 32 can swing synchronously. In addition, the four-linkage structure relatively evenly bears forces simultaneously and disperses the forces, resulting in balanced force distribution during the entire process of switching the seat frame 20 to the zero gravity posture, thereby preventing the gravity of the seat bracket from being concentrated at one hinge position, such as the hinge position between the first linkage plate 31 and the side plate 12, or the hinge position between the second linkage plate 32 and the side plate 12. The zero gravity line (the heart and knees of a user are close to the same horizontal line) is used as the reference line, and the front end of the seat frame plate 21 and the rear end of the seat frame plate 21 can be adjusted simultaneously and smoothly, so as to achieve the linear movement of the seat frame plate 21, thereby avoiding the phenomenon of lagging caused by force concentration. The coordination optimization can ensure that in a process of switching from the sitting posture or the TV posture to the zero gravity posture, the front end and rear end of the seat frame plate 21 can be adjusted simultaneously and smoothly, and the zero gravity line is used as the reference line to achieve the linear movement of the seat frame plate 21, so that the force is evenly applied to each part of the body of the user without the sense of pressure, thereby improving the comfort experience of the user. Therefore, the technical solution of one embodiment of the seat bracket effectively solves the problem of lagging during a switching process of the seat frame 20 in related technologies, leading to poor user comfort experience.

It should be noted that "deformation of the four-linkage structure" refers to the decrease or increase in an included angle between any adjacent two of the side plate 12, the first linkage plate 31, the second linkage plate 32 and the seat frame plate 21. The case that the front end of the seat frame plate 21 is adjusted to move towards the reference line, and the rear end of the seat frame plate 21 is adjusted to move towards the reference line may be that the front end of the seat frame plate 21 is adjusted to move upward towards the reference line, and the rear end of the seat frame plate 21 is adjusted to move downward towards the reference line; or may be that the front end of the seat frame plate 21 is adjusted to move downward towards the reference line, and the rear end of the seat frame plate 21 is adjusted to move upward towards the reference line.

It should be noted that when or after the first driving member 41 operates, the seat frame plate 21 swings to drive the first linkage plate 31 and the second linkage plate 32 to swing, specifically including the following two situations:

First situation: After the first driving member 41 operates, when the seat frame 20 is in the sitting posture or the TV posture, the second driving member 42 (see the details below) then cooperates with the first driving member 41 to operate to drive the seat frame plate 21 to swing to drive the first linkage plate 31 and the second linkage plate 32 to swing, so as to lift the seat frame 20 to the lifting posture, thereby facilitating the seat frame 20 to be in the zero gravity posture.

Second situation: When the first driving member 41 operates, a lifting plate 34 (see the details below) is driven to swing to enable the lifting plate 34 to drive the seat frame plate 21 to swing, and the seat frame plate 21 swings to drive the first linkage plate 31 and the second linkage plate 32 to swing, so that the seat frame 20 is switched among the sitting posture, the TV posture and the zero gravity posture.

The side plate 12, the first linkage plate 31, the second linkage plate 32 and the seat frame plate 21 in the present disclosure at least enclose a closed four-linkage structure, meaning that: when the numbers of the side plate 12, the first linkage plate 31, the second linkage plate 32 and the seat frame plate 21 are all one, a closed four-linkage structure is enclosed; when the number of the first linkage plate 31 or the second linkage plate 32 is two connection plates hinged to each other, the side plate 12, the first linkage plate 31, the second linkage plate 32 and the seat frame plate 21 can enclose a closed five-linkage structure; when the numbers of the first linkage plate 31 and the second linkage plate 32 are both two connection plates hinged to each other, the side plate 12, the first linkage plate 31, the second linkage plate 32 and the seat frame plate 21 can enclose a closed six-linkage structure; when the number of one of the first linkage plate 31 and the second linkage plate 32 is two connection plates hinged to each other and the number of the other one of the first linkage plate 31 and the second linkage plate 32 is three connection plates hinged to each other, the side plate 12, the first linkage plate 31, the second linkage plate 32 and the seat frame plate 21 can enclose a closed seven-linkage structure; and when the numbers of the first linkage plate 31 and the second linkage plate 32 are both three connection plates hinged to each other, the side plate 12, the first linkage plate 31, the second linkage plate 32 and the seat frame plate 21 can enclose a closed eight-linkage structure.

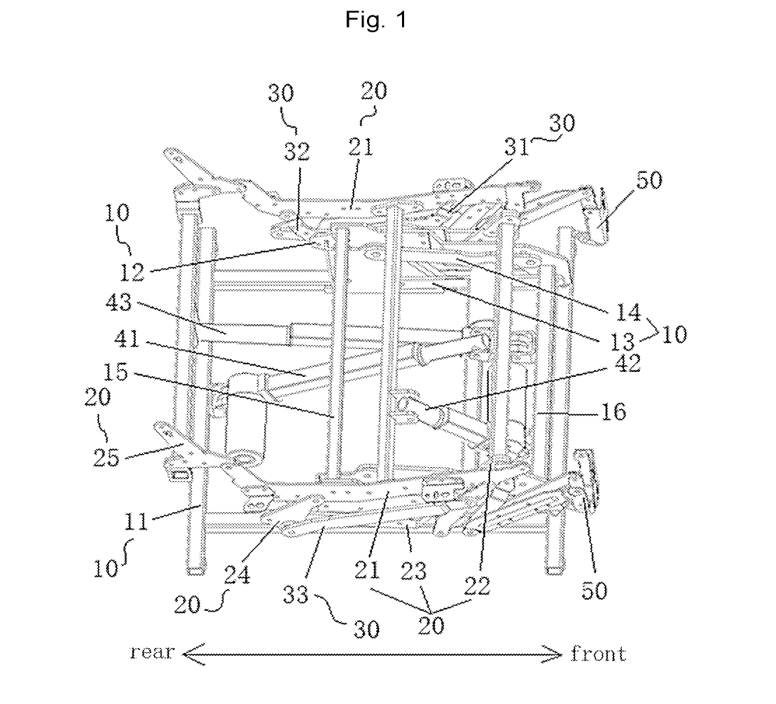

As shown in FIGS. 1 to 9, the first linkage plate 31 is located on the front side of the second linkage plate 32, the first end of the first linkage plate 31 is hinged to the middle of the side plate 12, the first end of the second linkage plate 32 is hinged to the rear end of the side plate 12, and the second end of the first linkage plate 31 and the second end of the second linkage plate 32 are both hinged to part of the seat frame plate 21 between the front end of the seat frame plate 21 and the rear end of the seat frame plate 21. This design can make the movement of the front end of the seat frame plate 21 and the rear end of the seat frame plate 21 more coordinated during switching of the posture of the seat frame plate 21, thereby avoiding the lagging phenomenon caused by force concentration during the movement of the front end of the seat frame plate 21 and the rear end of the seat frame plate 21. Furthermore, because the first linkage plate 31 is located on the front side of the second linkage plate 32, it can earlier respond to the movement requirements of the front end of the seat frame plate 21, so as to further optimize the dynamic balance of the seat frame plate 21.

In the above structure, by the arrangement of this four-linkage structure, the seat frame plate 21 can achieve smooth and stable movement when changing different postures, thereby avoiding the shaking and discomfort that may occur during switching of the posture of a traditional seat. The implementation effect is manifested as a user being able to feel more stable and comfortable experience when changing the posture of the seat. Application scenarios include homes, hospitals, nursing homes and other places that require comfortable sitting and lying experience, and this structure is particularly suitable for the elderly or those with physical disabilities to reduce physical exertion and discomfort during switching of the posture.

As shown in FIG. 1 to FIG. 9, the front end of the seat frame plate 21 moves upward towards the reference line by a first preset distance L1, the rear end of the seat frame plate 21 moves downward towards the reference line by a second preset distance L2, and the difference between the first preset distance L1 and the second preset distance L2 is greater than or equal to 20 mm and less than or equal to 40 mm. This set difference range is conducive to achieving the zero gravity posture of the seat frame 20 and simultaneously achieving the adjustment to a zero gravity state in which the heart and knees are close to the same horizontal line, and ensures that the movement of the seat frame plate 21 conforms to ergonomics to reduce the uneven force distribution on each part of the body of a user when switching postures, thereby improving the overall comfort and safety.

The design of the above structure ensures that when switching to the zero gravity posture, the lifting of the front end of the seat frame plate 21 and the downward movement of the rear end of the seat frame plate 21 can be associated with the state in which the heart and knees are close to the same horizontal line, thereby being convenient to achieve a smooth zero gravity effect. The "smooth" refers to the simultaneous movement of the front end of the seat frame plate 21 and the rear end of the seat frame plate 21, so that the amplitude of the change is minimized as much as possible when each end moves, that is, the change process is smooth. The user in the zero gravity posture can have comfortable experience of balanced force distribution on each part of the body without the sense of pressure. Application scenarios include occasions that require long-term rest, relieve physical fatigue or have special health requirements, such as rehabilitation therapy and rest rooms. The zero gravity posture is conducive to improving blood circulation and reducing pressure on the spine and joints.

The first preset distance L1 is greater than or equal to 50 mm and less than or equal to 115 mm, or the first preset distance L1 is greater than or equal to 70 mm and less than or equal to 95 mm. The first preset distance L1 is preferably 83.1 mm. The second preset distance L2 is greater than or equal to 20 mm and less than or equal to 85 mm, or the second preset distance L2 is greater than or equal to 40 mm and less than or equal to 65 mm. The second preset distance L2 is preferably 53.1 mm.

As shown in FIGS. 1 to 9, the chassis 10 further includes a front transverse rod 16 fixedly connected with the side plate 12, the seat frame 20 further has a lifting posture, the seat bracket further includes a second driving member 42 capable of being hinged to the front transverse rod 16, and the second driving member 42 is capable of driving the seat frame plate 21 to swing, so as to lift the seat frame 20 to the lifting posture. In this way, the versatility of the seat can be increased, allowing the user to freely switch among multiple postures. Furthermore, due to the independent control of the second driving member 42, the lifting angle of the seat frame plate 21 can be more accurately adjusted to meet the personalized requirements of different users, so as to improve comfort and use experience. The independent arrangement of the second driving member 42 allows the lifting action of the seat frame plate 21 to be independent of other posture changes, thereby providing more flexible use experience. The user can adjust the seat posture more freely to meet the requirements in different scenarios. Application scenarios include occasions that require physical therapy, muscle relaxation or improvement of blood circulation. The provision of the lifting posture helps the user adjust and restore the body in the zero gravity posture.

The second driving member 42 includes a driving rod fixedly connected with the seat frame plate 21 and a telescopic rod capable of being hinged to the front transverse rod 16. The telescopic rod can extend and retract and drive the driving rod to move back and forth, so that the driving rod drives the seat frame plate 21 to swing.

As shown in FIGS. 1 to 9, the seat frame 20 further has a standing posture, the chassis 10 further includes a first support plate 13 and a second support plate 14 disposed at intervals, two ends of the first support plate 13 are respectively hinged to the base 11 and the side plate 12, two ends of the second support plate 14 are respectively hinged to the base 11 and the side plate 12, the first driving member 41 is capable of driving the side plate 12 to swing, and when the side plate 12 swings, the first support plate 13 and the second support plate 14 are driven to swing so that the seat frame 20 is switched between the sitting posture and the standing posture. The design of the standing posture allows the seat to not only provide the sitting posture, the TV posture and the zero gravity posture, but also simulate a standing state. This not only increases the functional diversity of the seat, but also helps users with limited mobility (such as the elderly) stand up more easily from the seat, thereby improving the practicability of the seat.

The above structural design allows the seat to be smoothly switched from the sitting posture to the standing posture, thereby providing the user with a standing assistance function. When the user needs to leave the seat, the user can easily use the lifting function of the seat to reduce physical exertion and risk when standing. Application scenarios include homes, hospitals, nursing homes, and other places. This structure is particularly suitable for the elderly or those with limited mobility to help them stand up from the seat more safely and conveniently.

As shown in FIGS. 1 to 9, the side plate 12 includes a first plate body 121 and a second plate body 122 superposed left and right and arranged fixedly, two ends of the first support plate 13 are respectively hinged to the base 11 and the first plate body 121, two ends of the second support plate 14 are respectively hinged to the base 11 and the first plate body 121, two ends of the first linkage plate 31 are respectively hinged to the second plate body 122 and the seat frame plate 21, and two ends of the second linkage plate 32 are respectively hinged to the second plate body 122 and the seat frame plate 21. The first plate body 121 and the second plate body 122 which are arranged fixedly together form the side plate 12 to provide stronger stability and support force, and the hinge position between the first support plate 13 and the second support plate 14 is optimized, thereby ensuring more even force distribution of the four-linkage mechanism during deformation, and reducing the phenomenon of lagging that may occur due to structural rigidity problems.

The dual-plate body design formed together by the first plate body 121 and the second plate body 122 increases the stability and strength of the seat structure, and ensures the normal operation of the four-linkage structure. The seat is more stable in structure and has a longer service life when changing various postures. Application scenarios include occasions where frequent posture switching is required, such as rehabilitation rooms in hospitals and rest areas in nursing homes. The dual-plate body design can withstand more use pressure to ensure long-term stable operation of the seat.

Specifically, the first plate body 121 includes a first plate segment and a second plate segment in bent connection with the first plate segment, the first plate segment is closer to the center of the chassis 10 than the second plate segment, one end of the first support plate 13 and one end of the second support plate 14 are both hinged to the first plate segment, and the second plate segment is fixedly connected with the second plate body 122.

As shown in FIGS. 1 to 9, the seat frame 20 further includes a driving plate 22 connected with the first driving member 41, a first driven plate 23 hinged to the driving plate 22, and a second driven plate 24 hinged to the first driven plate 23 and the seat frame plate 21, the seat frame 20 further includes a footrest mechanism 50 swingably arranged on the seat frame plate 21, and the linkage mechanism 30 further includes a third linkage plate 33 hinged to the footrest mechanism 50 and the second driven plate 24. The chassis 10 further includes a front transverse rod 16 fixedly connected with the side plate 12, the seat frame 20 further has a lifting posture, the seat bracket further includes a second driving member 42 capable of being hinged to the front transverse rod 16, and the second driving member 42 is capable of driving the seat frame plate 21 to swing, so as to lift the seat frame 20 to the lifting posture. When the first driving member 41 drives the driving plate 22 to swing, the driving plate 22 drives the footrest mechanism 50 to swing by the first driven plate 23, the second driven plate 24 and the third linkage plate 33 sequentially so that the seat frame 20 is switched between the sitting posture and the TV posture, and in a case that the seat frame 20 is in the TV posture, in a process of switching the seat frame 20 to the lifting posture, the hinge position between the second driven plate 24 and the first driven plate 23 is a swing center of the seat frame plate 21. In this way, when the seat frame plate 21 swings, the swing of the seat frame plate 21 does not cause the position of the footrest mechanism 50 to change, that is, the position of the footrest mechanism 50 relative to the seat frame plate 21 remains unchanged.

As shown in FIGS. 1 to 9, the second driven plate 24 is a triangular plate, a first hinge point is formed at the hinge position between the second driven plate 24 and the first driven plate 23, a second hinge point is formed at the hinge position between the second driven plate 24 and the seat frame plate 21, a third hinge point is formed at the hinge position between the second driven plate 24 and the third linkage plate 33, and the first hinge point, the second hinge point and the third hinge point are respectively located on parts of three corners of the triangular plate. The triangular plate form can provide better mechanical stability, and the optimized hinge point distribution ensures more even force transmission during posture change to reduce the stress concentration in local areas, thereby reducing the lagging phenomenon and improving the comfort of users when switching postures. The triangular plate of the present disclosure is a structure similar to the shape of a triangular plate.

The use of the triangular plate not only increases the stability of the structure, but also optimizes the force transmission path, so that the movement of the seat frame plate 21 is more accurate. During posture switching of the seat frame plate 21, the movement trajectory is smoother, and friction and noise in a movement process are reduced. Application scenarios include occasions that require a quiet and comfortable use environment, such as libraries and high-end lounges. The design of the triangular plate can ensure the quietness and stability of the seat during posture switching.

As shown in FIGS. 1 to 9, a limiting member 61 is arranged on the side plate 12, and the limiting member 61 is limited to the seat frame plate 21, so that the seat frame 20 is maintained in the sitting posture or the TV posture. The arrangement of the limiting member 61 can prevent excessive displacement of the seat frame plate 21 in the movement process, thereby ensuring the stability of the seat in different postures such as the sitting posture, the TV posture and the zero gravity posture, avoiding the sense of insecurity of users during use, and improving the user experience of comfort and safety during posture switching of the seat frame 20. The limiting member 61 is preferably a limiting column, and a bottom surface of the second linkage plate 32 is provided with a limiting groove capable of abutting against and cooperating with the limiting column.

The arrangement of the limiting member 61 ensures that the seat frame plate 21 will not exceed the preset range during posture switching, thereby increasing the use safety of the seat. The user can feel more secure when changing the seat posture, and unexpected movements or posture changes are avoided. Application scenarios include occasions that require safe sitting and lying experience, such as homes, hospitals and nursing homes. The design of the limiting member 61 can ensure the safety and stability of the seat during posture switching.

As shown in FIGS. 1 to 9, the chassis 10 further includes a front transverse rod 16 fixedly connected with the side plate 12, the seat frame 20 further includes a backrest frame 25 hinged to the rear end of the seat frame plate 21, the seat bracket further includes a third driving member 43 capable of being hinged to the front transverse rod 16, the third driving member 43 is capable of driving the backrest frame 25 to swing, when or after the first driving member 41 operates, the seat frame plate 21 swings, and when the third driving member 43 drives the backrest frame 25 to swing, the seat frame 20 is switched among the sitting posture, the TV posture and the zero gravity posture. The independent drive design of the backrest frame 25 allows users to accurately adjust the backrest angle according to personal requirements. Whether in the sitting posture, the TV posture or the zero gravity posture, users can find the most comfortable backrest tilt angle, thereby further improving the comfort and personalized adaptability of the seat.

The independent drive design allows the movement of the backrest frame 25 to be independent of the seat frame plate 21, thereby increasing the flexibility of the seat posture change. Users can independently adjust the angle of the backrest frame 25 according to personal requirements, thereby achieving more personalized sitting and lying experience. Application scenarios include occasions that require personalized sitting and lying experience, such as homes and offices. The independent drive design can meet the personalized requirements of different users for the backrest angle.

The third driving member 43 includes a driving rod fixedly connected with the backrest frame 25 and a telescopic rod capable of being hinged to the front transverse rod 16. The telescopic rod can extend and retract and drive the driving rod to move back and forth, so that the driving rod drives the backrest frame 25 to swing.

As shown in FIGS. 1 to 9, the seat frame 20 further includes a footrest mechanism 50 swingably arranged on the seat frame plate 21, and the linkage mechanism 30 further includes a third linkage plate 33 hinged between the footrest mechanism 50 and the first driving member 41. The footrest mechanism 50 includes a pedal 51, a first front connection plate 52, a second front connection plate 53, a first rear connection plate 54 and a second rear connection plate 55. The pedal 51 and the seat frame plate 21 are disposed at intervals, the first end of the first front connection plate 52 is hinged to the pedal 51, the first end of the first rear connection plate 54 is hinged to the second end of the first front connection plate 52, the second end of the first rear connection plate 54 is hinged to the front end of the seat frame plate 21, the first end of the second front connection plate 53 is hinged to the pedal 51, the first end of the second rear connection plate 55 is hinged to the second end of the second front connection plate 53, the second end of the second rear connection plate 55 is hinged to the seat frame plate 21, the second front connection plate 53 is hinged to the first rear connection plate 54, and one end of the third linkage plate 33 is hinged to the second rear connection plate 55. The cooperation between the footrest mechanism 50 and the third linkage plate 33 can ensure that the footrest mechanism 50 can be smoothly extended and folded regardless of the sitting posture, the TV posture or the zero gravity posture, thereby avoiding the occurrence of lagging and unnatural movement of the footrest mechanism 50 during posture switching, and improving the comfort of users when changing different postures. Especially, the experience in the zero gravity posture makes the pedal movement more conform to the ergonomic principle.

The first driving member 41 includes a telescopic rod 411 hinged to the base 11 and a driving rod 412 hinged to the telescopic rod 411, the seat frame 20 further includes a driving plate 22 fixedly connected with the driving rod 412, the side plate 12 is hinged to the driving plate 22, the driving rod 412 is fixedly connected with the driving plate 22, when the telescopic rod 411 extends or retracts, the driving rod 412 is capable of being driven to swing so that the driving rod 412 drives the driving plate 22 to swing, when the driving plate 22 swings, the side plate 12 is driven to swing, or when the driving plate 22 swings, the footrest mechanism 50 is driven to fold or unfold. When the telescopic rod 411 performs telescopic movement, the driving rod 412 can be driven to move back and forth, so that the driving rod 412 can drive the driving plate 22 to swing. The telescopic rod 411 is preferably an electric push rod.

The design of the footrest mechanism 50 ensures that the pedal 51 can be accurately extended and folded during posture switching, thereby increasing the comfort and functionality of the seat. Users can enjoy more natural and comfortable foot support when changing seat postures. Application scenarios include occasions that require comfortable foot support, such as homes, offices and hospitals. The design of the footrest mechanism 50 can meet the requirements of users for foot support in different postures, thereby providing more comprehensive sitting and lying experience. During use, when a user needs to extend the pedal 51, the accurate movement of the footrest mechanism 50 is driven by the extension and retraction of the first driving member 41 to extend or fold the pedal 51, thereby meeting the requirements for foot support in different postures.

The linkage design formed by the pedal 51, the first front connection plate 52, the second front connection plate 53, the first rear connection plate 54, the second rear connection plate 55 and the third linkage plate 33 ensures that the movement of the footrest mechanism 50 is synchronized with the posture change of the seat frame plate 21, so as to avoid the discontinuity of the footrest mechanism 50 during posture switching of the seat frame 20 to make the posture change process of the seat frame 20 more natural, thereby significantly improving the comfort experienced by the user during posture switching of the seat frame 20.

The linkage design formed by the pedal 51, the first front connection plate 52, the second front connection plate 53, the first rear connection plate 54, the second rear connection plate 55 and the third linkage plate 33 makes the movement of the footrest mechanism 50 more accurate and coordinated, so that the footrest mechanism 50 can be folded or extended to achieve the smooth change among different postures of the seat frame 20. Users can feel more natural and comfortable pedal movement during posture switching. Application scenarios include occasions that require foot support and relaxation, such as home theaters and massage rooms. The multi-level linkage design can ensure the stability and comfort of the footrest mechanism 50 during posture switching.

When the seat frame in a related technology is maintained in the sitting posture or the TV posture or the zero gravity posture, because the gravity of the seat bracket is concentrated at the hinge position between the seat frame and the base, the hinge position between the seat frame and the base is prone to lagging, and the seat frame is unstable during switching among the sitting posture, the TV posture and the zero gravity posture, leading to poor user comfort experience.

In order to solve the above problems, when the seat frame 20 is in the sitting posture, the TV posture or the zero gravity posture, the front end of the side plate 12 abuts against the base 11. The rear end of the side plate 12 abuts against and cooperates with the base 11 to provide additional support. When the seat frame 20 is switched to the zero gravity posture, this design can effectively prevent the side plate 12 from swinging to ensure the stability of the seat frame 20 during switching among various postures and avoid the side plate 12 from swinging, thereby providing users with safer use experience.

A damping member 71 capable of abutting against and cooperating with the front end of the side plate 12 is arranged on the base 11. The damping member 71 is preferably a damping cushion. The arrangement of the damping member 71 can absorb and reduce the impact force and vibration generated when the side plate 12 swings, thereby improving the stability and comfort of the seat bracket during movement, prolonging the service life of the seat bracket, and reducing the possibility of component wear and noise generation under long-term use.

Application scenarios include occasions where it is necessary to reduce movement noise and avoid component wear, such as high-end lounges and noise-sensitive residential areas. The damping member 71 can ensure the quietness and stability of the seat bracket during posture switching.

The chassis 10 further includes a rear transverse rod 15 fixedly connected with the side plate 12, and when the seat frame 20 is in the sitting posture or the TV posture or the zero gravity posture, the rear transverse rod 15 abuts against the middle of the base 11. The addition of the rear transverse rod 15 can enhance the overall structural stability of the seat bracket. In the sitting posture, the TV posture and the zero gravity posture, the rear transverse rod 15 abuts against and cooperates with the middle of the base 11 to effectively prevent the side plate 12 from swinging, thereby ensuring the stability of the seat bracket during posture switching and the safety of the user during sitting.

Application scenarios include occasions that require high-strength support and stability, such as rehabilitation rooms in hospitals and rest areas in nursing homes. The design of the rear transverse rod 15 can ensure that the seat bracket can withstand more use pressure, thereby ensuring the stability of the seat during long-term operation.

A support protrusion 111 capable of abutting against and cooperating with the rear transverse rod 15 is arranged in the middle of the base 11. The arrangement of the support protrusion 111 can provide more secure support for the rear transverse rod 15 to ensure that during posture switching of the seat bracket, the contact between the rear transverse rod 15 and the base 11 is more stable, thereby further enhancing the structural strength and stability of the seat bracket, and being conducive to dispersing the pressure on the seat during the change process to avoid local overload.

Application scenarios include occasions where it is necessary to frequently switch postures or bear relatively large use loads, such as home theaters and rest areas in fitness rooms. The support protrusion 111 can ensure that the seat bracket maintains good structural stability and bearing capacity under various posture changes, thereby providing safer and more comfortable use experience.

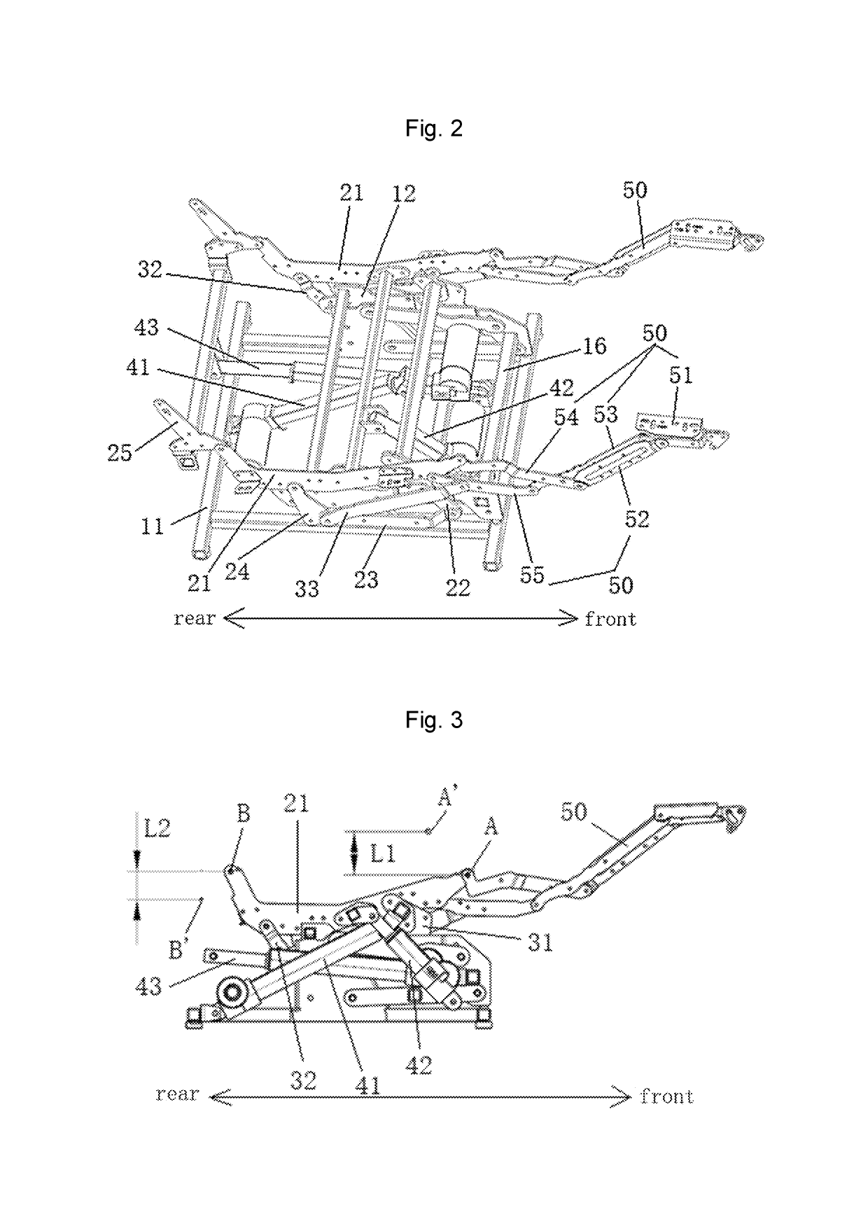

As shown in FIGS. 2 to 5, in a process of switching the seat frame 20 from the TV posture to the zero gravity posture, the position change of the seat frame plate 21 is as follows:

In FIG. 3, a point A is a center point of the hinge position between the front end of the seat frame plate 21 and the footrest mechanism 50 when the seat frame 20 is in the TV posture, and this point is closest to the knee position, so that the upward movement distance of the knee can be approximately estimated by referring to this point. A point A' is a center point of the hinge position between the front end of the seat frame plate 21 and the footrest mechanism 50 when the seat frame 20 is in the zero gravity posture.

In FIGS. 3 and 5, a point B is a center point of the hinge position between the backrest frame 25 and the rear end of the seat frame plate 21. The downward movement distance of the heart cannot be estimated only by the downward movement distance of the point B, so that a backward tilt change angle of the backrest frame 25 is newly introduced. The downward movement distance of the heart is estimated by together referring to the downward movement distance of the point B and the backward tilt change angle of the backrest frame 25. A point B' is a center point of the hinge position between the rear end of the seat frame plate 21 and the backrest frame 25 when the seat frame 20 is in the zero gravity posture. The backward tilt change angle of the backrest frame 25 refers to a change angle of the backrest frame 25 changing from the sitting posture or the TV posture to the zero gravity posture on the basis of a zero gravity included angle a which is an included angle between a center line of the backrest frame 25 in a length direction and a mounting plane of the seat frame plate 21. As shown in FIGS. 2 and 5, the point A can move upward vertically by 83.1 mm to the point A', the point B can move downward vertically by 53.1 mm to the point B', and the backward tilt change angle of the backrest frame 25 is 32°.

In an embodiment of the seat bracket, because the backrest frame 25 can be adjusted independently, when the seat frame 20 is in the zero gravity posture, an included angle between the backrest frame 25 and the seat frame plate 21 can reach a maximum such that the backrest frame 25 is parallel to the horizontal plane. Therefore, the backward tilt change angle of the backrest frame 25 is less than or equal to 54° and greater than or equal to 25°, or the backward tilt change angle of the backrest frame 25 is less than or equal to 40° and greater than or equal to 28°.

In the present disclosure, the movement of the first driving member 41 has three positions. The first position is a retracted position of the first driving member 41, the second position is a semi-extended position of the first driving member 41, and the third position is a fully-extended position of the first driving member 41. The total length of the first driving member 41 at the second position is greater than the total length of the first driving member 41 at the first position, and the total length of the first driving member 41 at the third position is greater than the total length of the first driving member 41 at the second position.

As shown in FIG. 1, when the seat frame 20 is in the sitting posture: the backrest frame 25 maintains a nearly upright state, the first driving member 41 is located at a semi-extended position, the footrest mechanism 50 is folded, and the first support plate 13 and the second support plate 14 remain folded. In the sitting posture, the front end of the first plate body 121 abuts against the base 11, and the front end of the first plate body 121 fixedly connected with the rear transverse rod 15 abuts against the base 11.

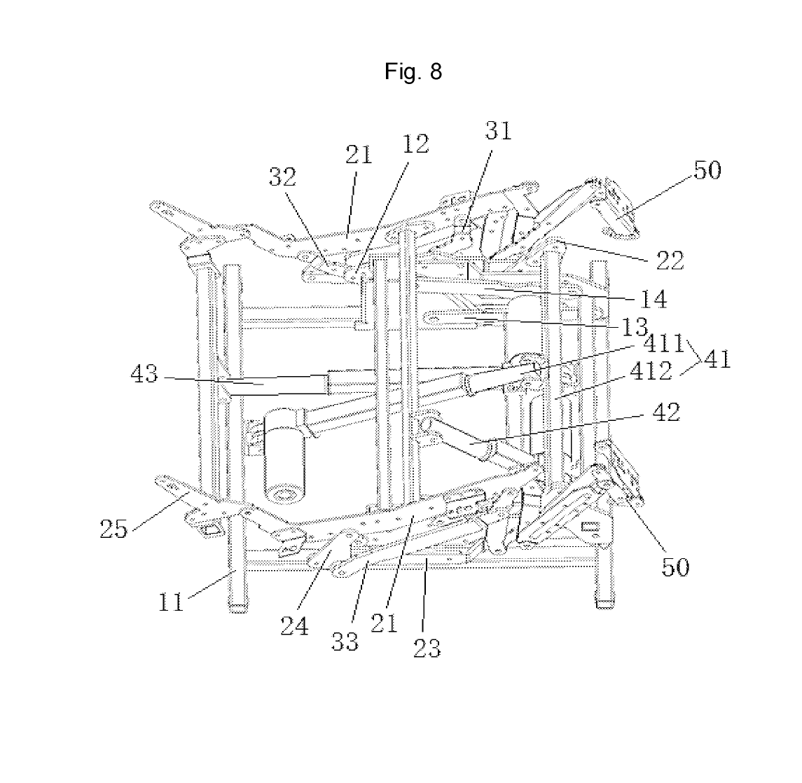

As shown in FIG. 8, when the seat frame 20 in the sitting posture is in a lifting posture: in a sitting posture state, the second driving member 42 extends to lift the front end of the seat frame plate 21.

As shown in FIGS. 2 and 3, when the seat frame 20 is in the TV posture: in a sitting posture state, the first driving member 41 retracts from the semi-extended position to drive the footrest mechanism 50 to extend, and the backrest frame 25 maintains a nearly upright state. In this case, the first driving member 41 is in the retracted position, and the first support plate 13 and the second support plate 14 remain folded.

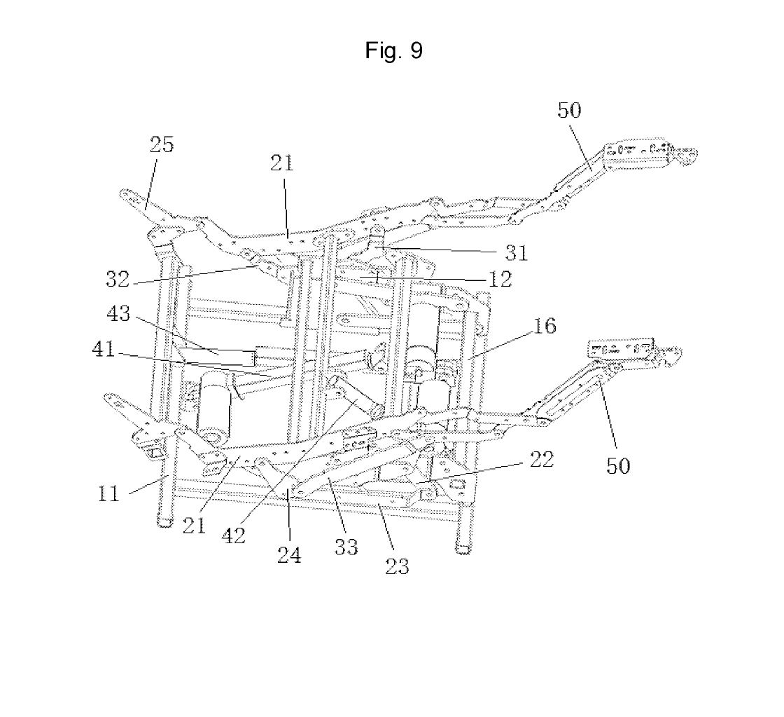

As shown in FIG. 9, when the seat frame 20 in the TV posture is in a lifting posture: in a TV posture state, the second driving member 42 extends to lift the front end of the seat frame plate 21.

In an embodiment of the seat bracket, the seat frame 20 further has a lying posture. When the seat frame 20 is in the lying posture: in a TV posture state, the footrest mechanism 50 remains extended, the third driving member 43 retracts to drive the backrest frame 25 to tilt backward, and the first support plate 13 and the second support plate 14 remain folded.

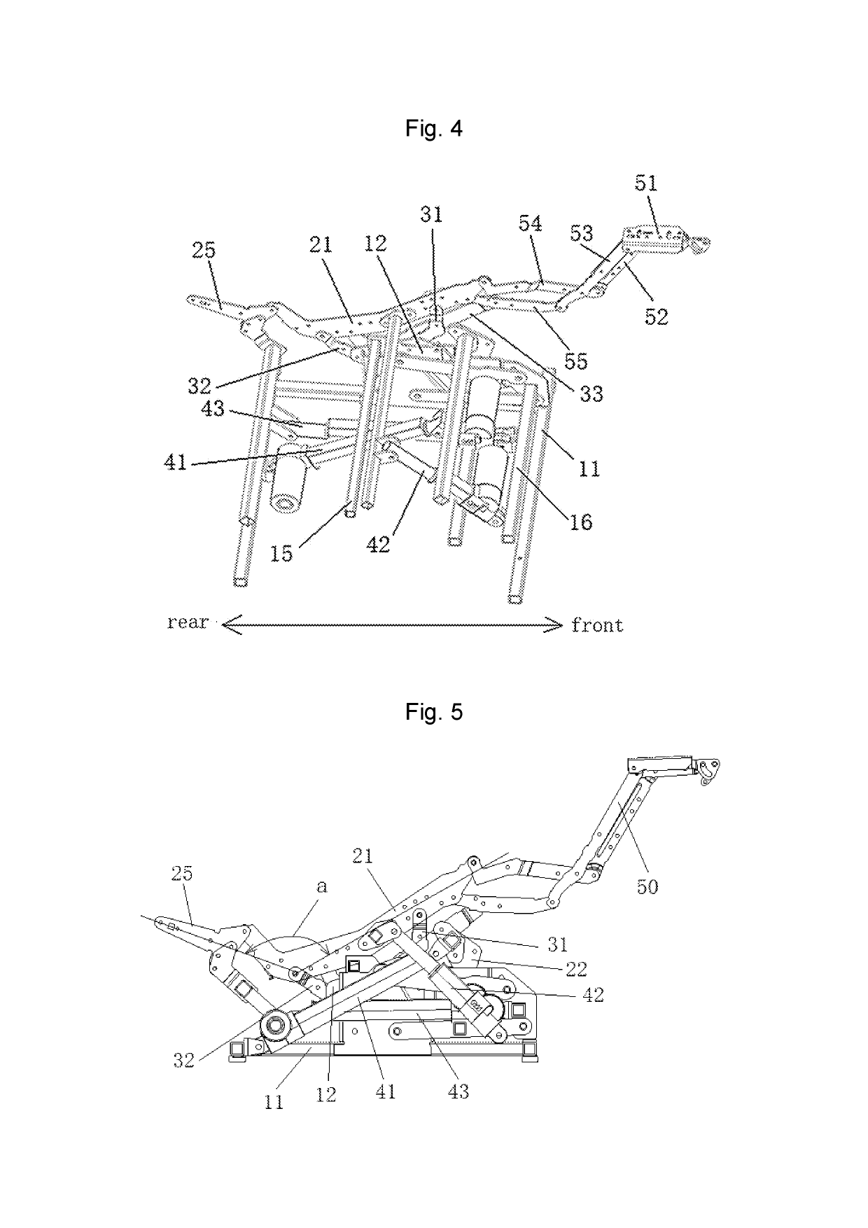

As shown in FIGS. 4 and 5, the seat frame 20 is in the zero gravity posture: in a TV posture state, the third driving member 43 retracts to drive the backrest frame 25 to tilt backward. The footrest mechanism 50 remains extended, and the first support plate 13 and the second support plate 14 remain folded. In order to facilitate the adjustment of the seat frame 20, the second driving member 42 extends to lift the front end of the seat frame plate 21, and the hinge position between the second driven plate 24 and the first driven plate 23 is taken as a swing center of the seat frame plate 21 for adjustment to the zero gravity posture (so that the heart and knees are close to the same horizontal line, the force bearing area of the human body is increased, and the force is evenly applied to each part of the body without sense of pressure).

As shown in FIGS. 4 and 5, the seat frame 20 is in the zero gravity posture: in a lying posture state, the backrest frame 25 remains tilted backward, the footrest mechanism 50 remains extended, the first support plate 13 and the second support plate 14 remain folded, the second driving member 42 extends to lift the front end of the seat frame plate 21, and the hinge position between the second driven plate 24 and the first driven plate 23 is taken as a swing center of the seat frame plate 21 for adjustment to the zero gravity posture (so that the heart and knees are close to the same horizontal line, the force bearing area of the human body is increased, and the force is evenly applied to each part of the body without sense of pressure).

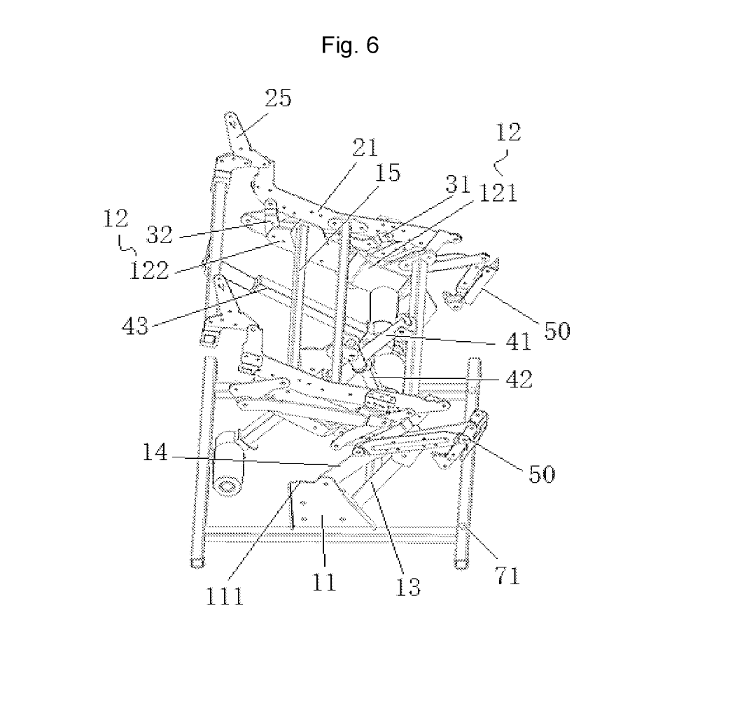

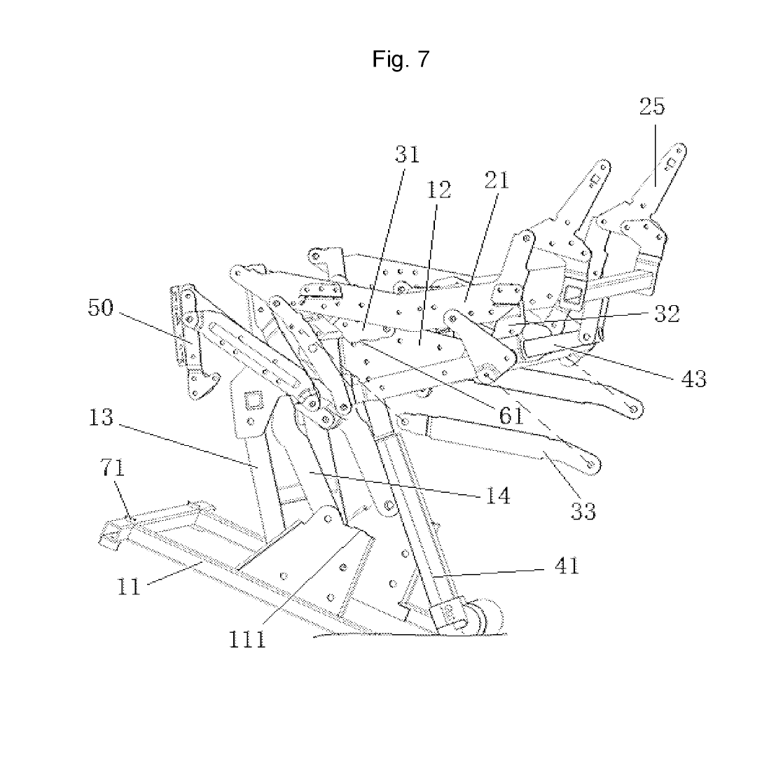

As shown in FIGS. 6 and 7, when the seat frame 20 is in the standing posture: in a sitting posture state, the first driving member 41 continues to extend from the semi-extended position to drive the entire seat frame plate 21 to move forward and upward, so as to leave the base 11, and in this case, the first driving member 41 is in the fully-extended position. The seat frame plate 21 remains basically unchanged, the first support plate 13 and the second support plate 14 remains extended, and the footrest mechanism 50 remains folded.

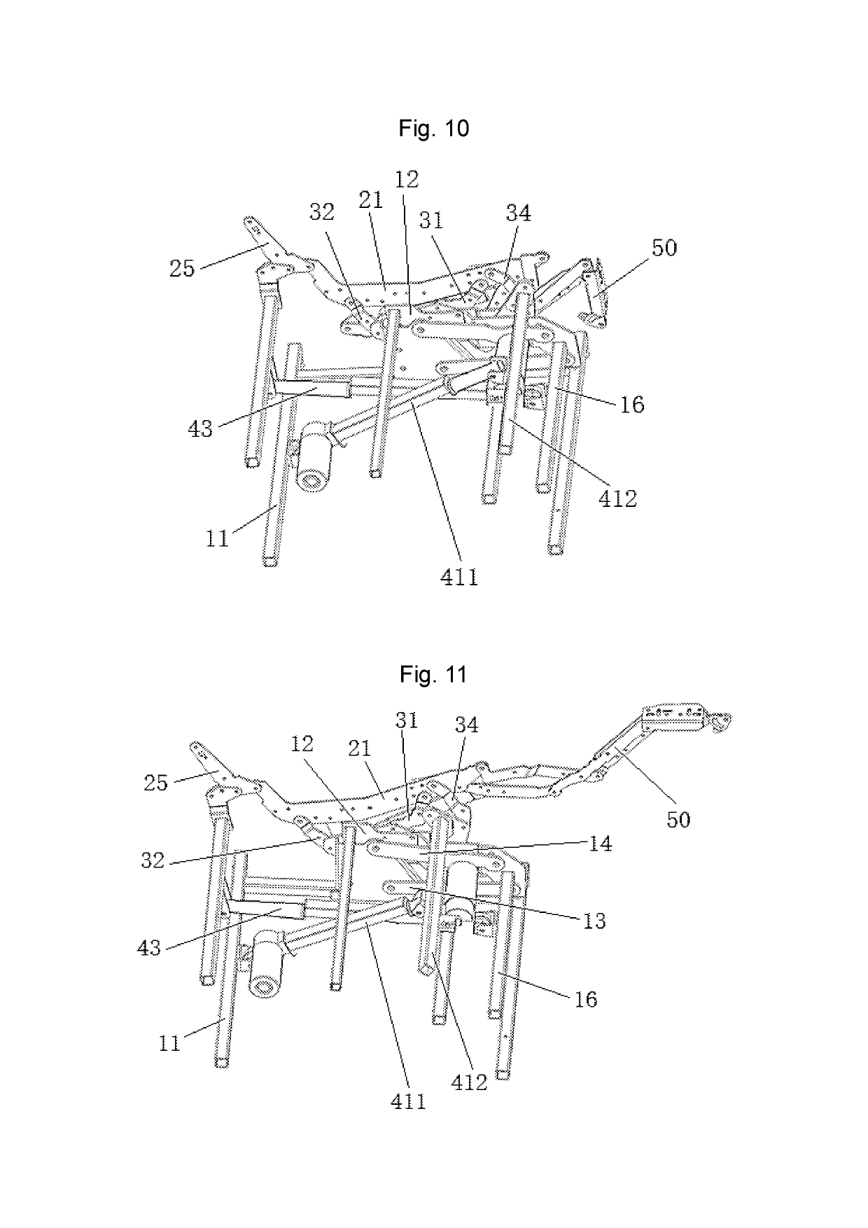

In another embodiment of a seat bracket of the present disclosure, as shown in FIG. 10 to FIG. 12, the difference from one embodiment of the seat bracket is that another embodiment of the seat bracket omits the second driving member 42 and only uses the first driving member 41 and the third driving member 43, and the seat bracket further includes a lifting plate 34 hinged to the seat frame plate 21 and the first driving member 41. Specifically, the first driving member 41 drives the seat frame plate 21 to swing by the lifting plate 34, so that the seat frame 20 is switched among the sitting posture, the TV posture and the zero gravity posture. The use of the lifting plate 34 can further optimize the force transmission path to ensure that the seat frame plate 21 can move more smoothly when swinging, so as to reduce the impact force during movement, so that the switching among the sitting posture, the TV posture and the zero gravity posture of the seat frame 20 is smoother.

As shown in FIGS. 10 to 12, the seat bracket further includes a lifting plate 34 hinged to the seat frame plate 21 and the first driving member 41, and the first driving member 41 drives the seat frame plate 21 to swing by the lifting plate 34 and can be linked with the footrest mechanism 50 to swing, so that the seat frame 20 is switched between the sitting posture and the TV posture. The arrangement of the lifting plate 34 enables the driving member to transmit the force more efficiently, so as to achieve the rapid change of postures of the seat frame 20, thereby improving the response speed and operation convenience of the seat posture change. Application scenarios include home entertainment, leisure places, etc. Users can rapidly adjust the posture to the TV posture according to TV watching or reading requirements, so as to enjoy more relaxed sitting posture experience.

Specifically, the seat frame 20 further includes a driving plate 22 fixedly connected with the first driving member 41, the side plate 12 is hinged to the driving plate 22, the first driving member 41 includes a telescopic rod 411 hinged to the base 11 and a driving rod 412 hinged to the telescopic rod 411, the seat frame 20 further includes a driving plate 22 fixedly connected with the driving rod 412, and the driving plate 22 is hinged to the seat frame plate 21 by the lifting plate 34.

When the seat frame 20 is in the standing posture: the first driving member 41 continues to extend from the semi-extended position to drive the entire seat frame plate 21 to move forward and upward, so as to leave the base 11, and in this case, the first driving member 41 is in the fully-extended position.

As shown in FIG. 10, when the seat frame 20 is in the sitting posture: the first driving member 41 is in the semi-extended position.

As shown in FIG. 11, when the seat frame 20 is in the TV posture: the first driving member 41 retracts from the semi-extended position to drive the footrest mechanism 50 to extend, and simultaneously, the front end of the seat frame plate 21 is lifted. In this case, the third driving member 43 remains stationary, so that the backrest frame 25 maintains a nearly upright state, and the first driving member 41 is in the retracted position.

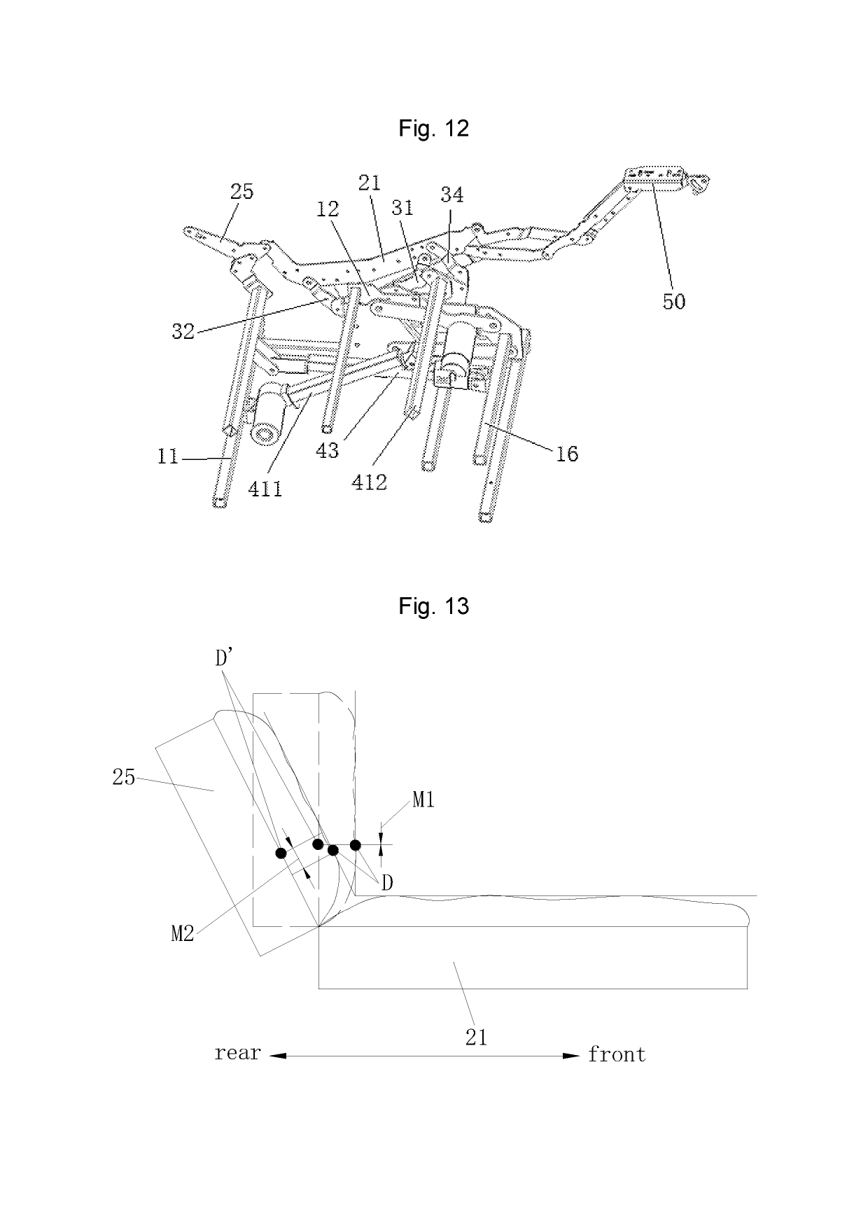

As shown in FIG. 12, when the seat frame 20 is in the zero gravity posture: the footrest mechanism 50 remains extended, and simultaneously, the third driving member 43 retracts to drive the backrest frame 25 to tilt backward, thereby achieving zero gravity posture adjustment.

Seats with a multi-posture change function are provided in related technologies. With the improvement of living standards, people's requirements for the comfort of seats are also increasing. A seat is usually provided with a mechanical extension apparatus, so that the seat can be changed between any two postures of a sitting posture, a zero gravity posture, a TV posture and a lying posture. When the seat changes from the sitting posture to the TV posture, a footstool of the seat extends forward, and an angle between a backrest part and a sitting part of the seat remains basically unchanged. When the seat changes from the TV posture to the lying posture, the footstool is further lifted forward and upward compared to the TV posture, and the backrest part is significantly tilted backward.

However, during the change from the sitting posture to the lying posture, because the backrest part and the sitting part of the seat are separated, there is a relatively large gap, which will cause the backrest part of the seat to move in misalignment relative to the back of a user, making it easy to pull out the jacket of the user and resulting in poor experience.

In related technologies, as shown in FIG. 13, the chassis includes a base and a side plate swingably arranged on the base. A seat frame is swingably arranged on the side plate and has at least three of a sitting posture, a TV posture, a zero gravity posture and a lying posture. The seat frame includes a swingable seat frame plate 21 and a backrest frame 25, the front end of the backrest frame 25 is hinged to the seat frame plate 21, the backrest frame 25 is a part of the backrest part of the seat, and the seat frame plate 21 is a part of the sitting part of the seat. When the seat frame plate 21 swings and the backrest frame 25 swings, the seat frame 20 is switched between any two postures of the sitting posture, the TV posture, the zero gravity posture and the lying posture. In a case that the seat frame is in the sitting posture or the TV posture, when a user uses the seat, one point of contact between the back of the user and the backrest part of the seat is denoted as a point D, and the position of the backrest frame 25 corresponding to the point D is denoted as a point D'; in this case, the point D' is located at a first operating position, and there is a first distance M1 between the point D' in a direction parallel to the backrest part and the point D; and in this case, the first distance M1 is 0, indicating that the jacket can fit the backrest part without misalignment. When the user uses the seat, in a case that the seat frame is in the zero gravity posture or the lying posture, the point D' is located at a second operating position, there is a second distance M2 between the point D' in the direction parallel to the backrest part and the point D, and the second distance M2 is greater than 0; the point D' generates misalignment backward in the direction parallel to the backrest part relative to the point D; and furthermore, because the jacket always fits the backrest part, but the backrest part moves a certain distance backward relative to the user, in this case, the jacket of the user is easily pulled out, causing a back rubbing situation and resulting in poor experience.

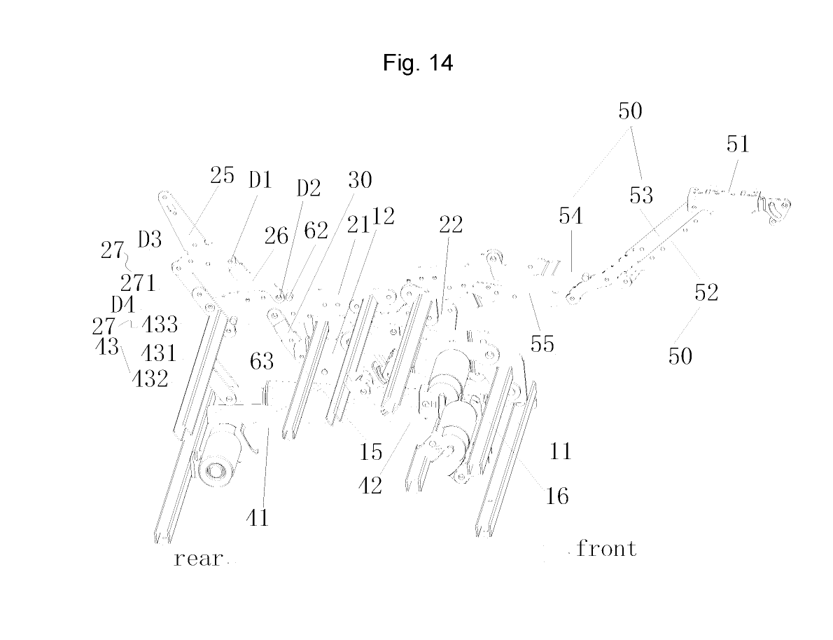

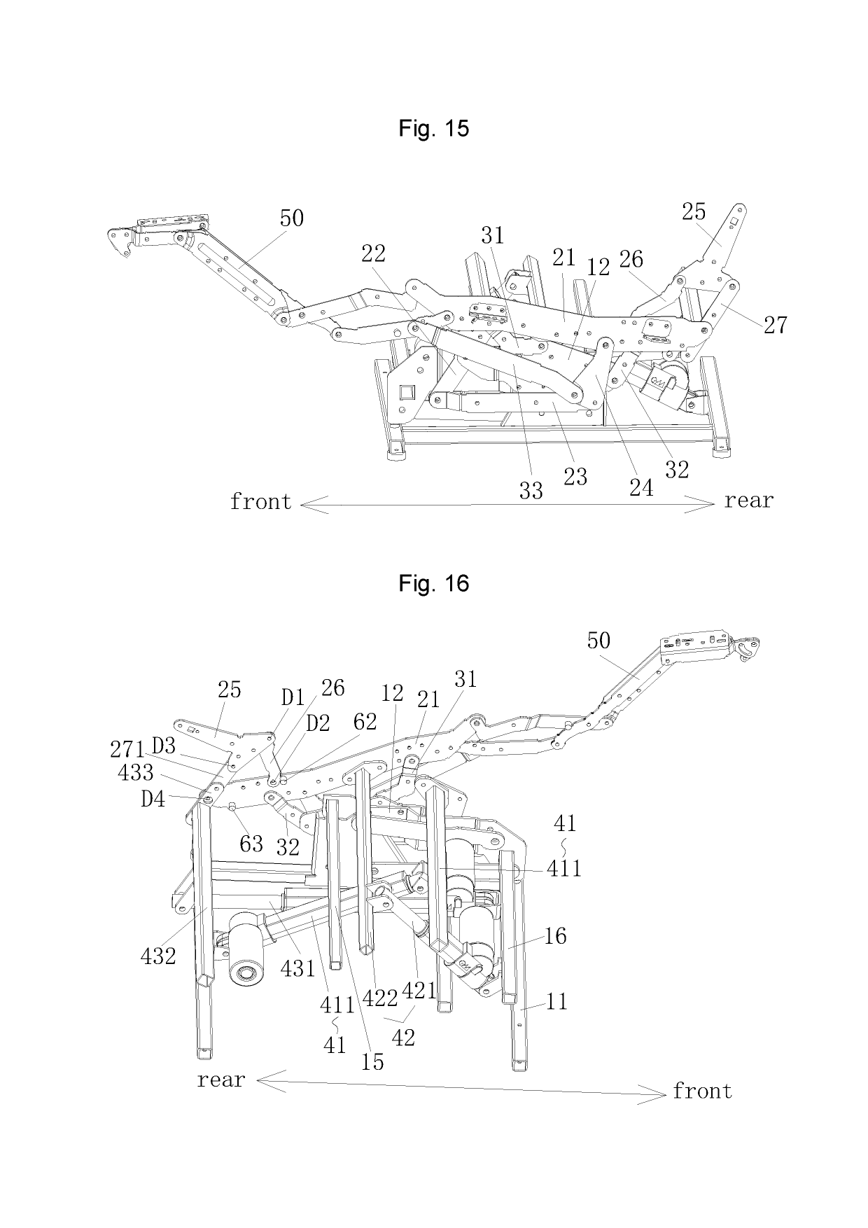

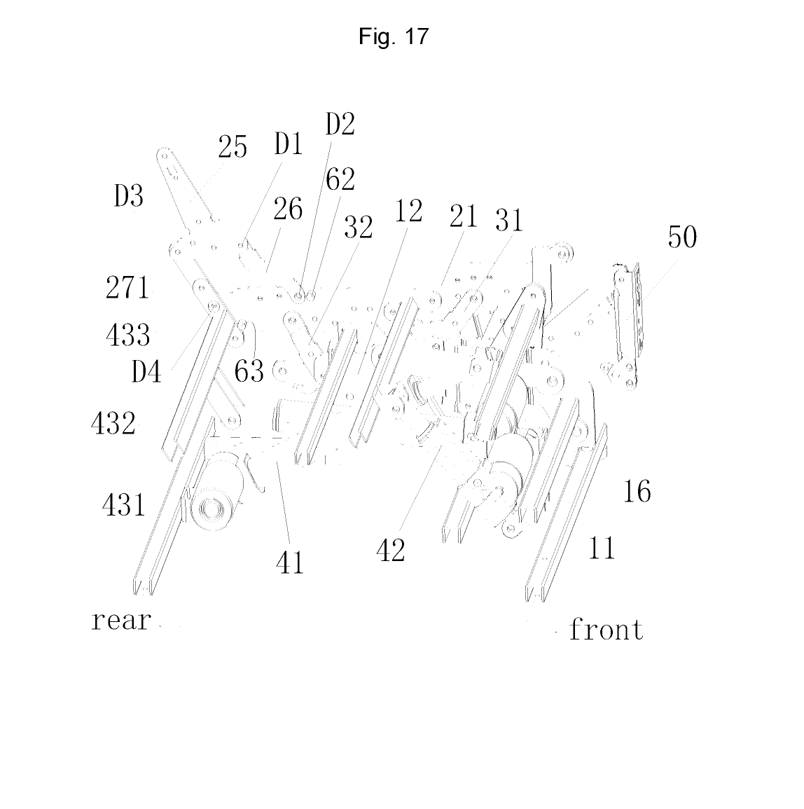

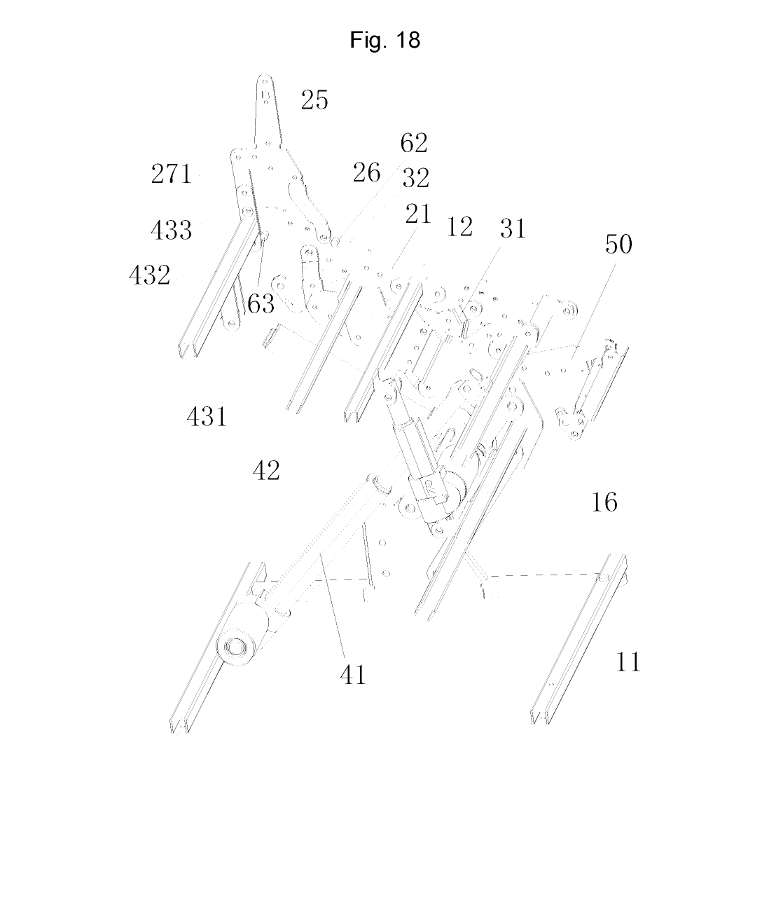

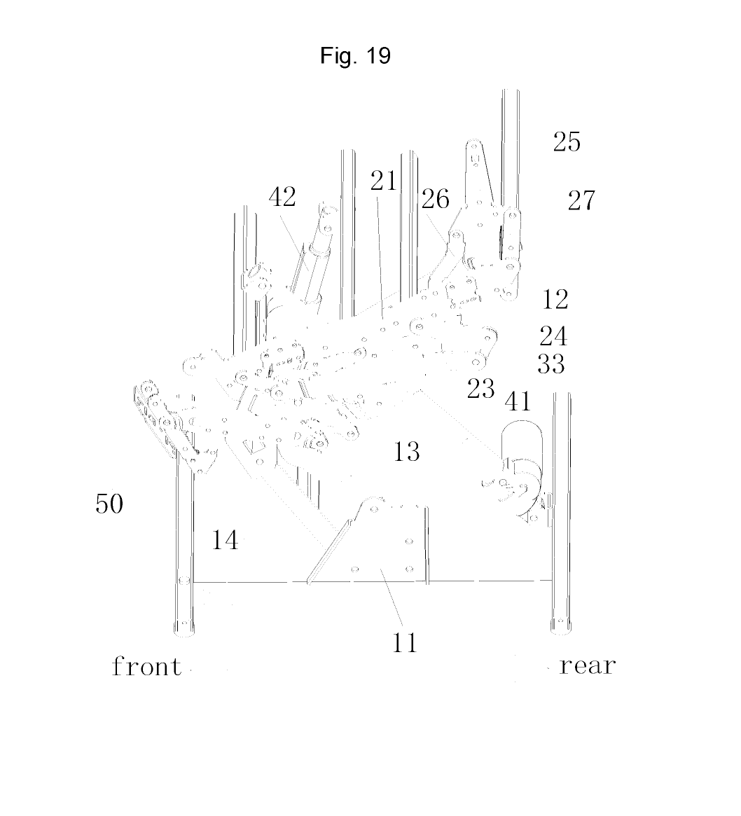

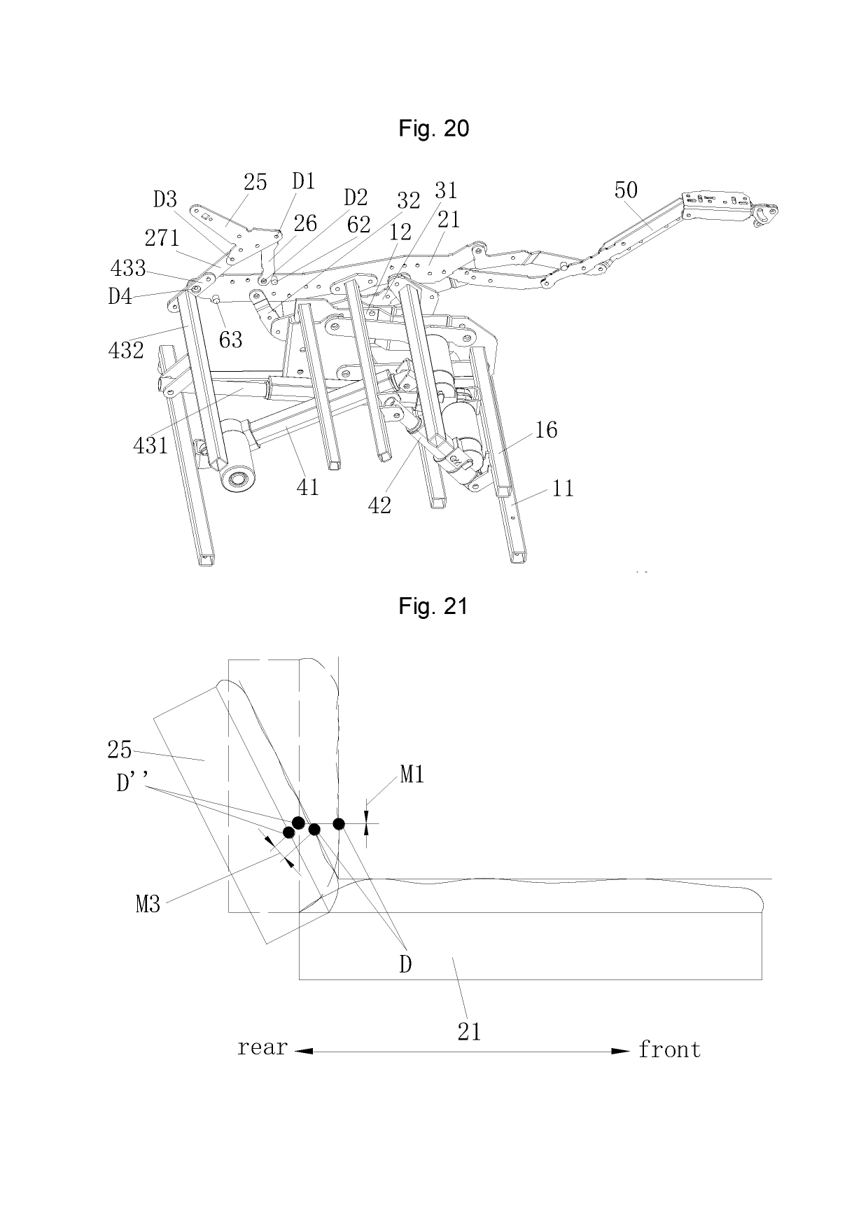

In order to solve the above problems, according to one aspect of the present disclosure, a seat bracket is provided. As shown in FIG. 14 to FIG. 21, Another embodiment of the seat bracket includes: a chassis 10, a seat frame 20, a first driving member 41, a linkage mechanism 30 and a third driving member 43. The chassis 10 includes a base 11, a side plate 12 swingably arranged on the base 11, and a front transverse rod 16 fixedly connected with the side plate 12. The seat frame 20 is swingably arranged on the side plate 12 and has a sitting posture, a TV posture, a zero gravity posture and a lying posture, and the seat frame 20 includes a swingable seat frame plate 21, a follow-up assembly and a backrest frame 25. Two ends of the follow-up assembly are respectively hinged between the seat frame plate 21 and the backrest frame 25, a hinge point 1 D1 is formed at the hinge position between one end of the follow-up assembly and the backrest frame 25, and a hinge point 2 D2 is formed at the hinge position between the other end of the follow-up assembly and the seat frame plate 21. The follow-up assembly is capable of swinging about the hinge point 2 D2, so that the hinge point 1 D1 has a first position and a second position. The first driving member 41 is arranged on the base 11, the linkage mechanism 30 is respectively hinged to the side plate 12 and the seat frame plate 21, and when or after the first driving member 41 operates, the seat frame plate 21 swings to drive the linkage mechanism 30 to swing. The third driving member 43 is capable of being hinged to the front transverse rod 16 and connected with the follow-up assembly, the third driving member 43 is capable of driving the backrest frame 25 to swing by the follow-up assembly, and when the seat frame plate 21 swings and the backrest frame 25 swings, the seat frame 20 is switched among the sitting posture, the TV posture, the zero gravity posture and the lying posture. When the seat frame 20 is in the sitting posture or the TV posture, the hinge point 1 D1 is located at the first position. When the seat frame 20 is in the zero gravity posture or the lying posture, the hinge point 1 D1 is located at the second position, and the second position is located on the front side of the first position in a horizontal direction. It should be noted that the positional change of the hinge point 1 D1 mentioned above is relative to the seat frame plate 21 and has no relation to the ground environment; the position of the hinge point 2 D2 is unchanged relative to the seat frame plate 21 and also has no relation to the ground environment.

According to the technical solution of another embodiment of the seat bracket, when a user uses the seat and switches the seat frame 20 from the sitting posture to the lying posture, because the second position is located on the front side of the first position in the horizontal direction, the position of the backrest frame 25 in the lying posture moves a certain distance forward relative to the position of the backrest frame 25 in the sitting posture, so as to compensate for the distance of misaligned movement between the back of the user and the backrest part of the seat, thereby ensuring that the jacket always fits the backrest part while reducing the possibility of misalignment between the jacket and the backrest part, reducing the probability that the jacket of the user is pulled out, and improving the experience. Therefore, the technical solution of another embodiment of the seat bracket effectively solves the problem that the jacket of the user is pulled out in related technologies, leading to poor experience.

It should be noted that when or after the first driving member 41 operates, the seat frame plate 21 swings to drive the linkage mechanism 30 to swing, specifically including the following two situations:

First situation: After the first driving member 41 operates, when the seat frame 20 is in the sitting posture or the TV posture, the second driving member 42 then cooperates with the first driving member 41 to operate to drive the seat frame plate 21 to swing to drive the linkage mechanism 30 to swing, so as to lift the seat frame 20 to the lifting posture, thereby facilitating the seat frame 20 to be in the zero gravity posture.

Second situation: When the first driving member 41 operates, a lifting plate 34 is driven to swing to enable the lifting plate 34 to drive the seat frame plate 21 to swing, and the seat frame plate 21 swings to drive the linkage mechanism 30 to swing, so that the seat frame 20 is switched among the sitting posture, the TV posture and the zero gravity posture.

Specifically, as shown in FIG. 21, the backrest frame 25 is a part of the backrest part of the seat, and the seat frame plate 21 is a part of the sitting part of the seat. In a case that the seat frame 20 is in the sitting posture or the TV posture, when a user uses the seat, one point of contact between the back of the user and the backrest part of the seat is denoted as a point D (the meaning of the point D is the same as that of the point D in related technologies), and the position of the backrest frame 25 corresponding to the point D is denoted as a point D''; in this case, the point D'' is located at the first operating position mentioned in related technologies, and there is a first distance M1 between the point D'' in a direction parallel to the backrest part and the point D; and the first distance M1 is 0, indicating that the jacket can fit the backrest part without misalignment. When the user uses the seat, in a case that the seat frame 20 is in the zero gravity posture or the lying posture, the point D'' is located at a third working position, there is a third distance M3 between the point D'' in the direction parallel to the backrest part and the point D, and the third distance M3 is less than the second distance M2. Although there is still a misalignment situation between the point D'' and the point D and the jacket always fits the backrest part, the backrest part with the improved structure in the present disclosure moves a certain distance forward relative to the user, thereby reducing the overall misalignment distance. In this case, the jacket of the user is not easily pulled out, so as to reduce the back rubbing situation and improve the experience. In addition, the gap between the backrest part and the sitting part of the seat is also reduced, so as to further improve the experience.

The backrest part of the present disclosure includes a backrest frame 25 and a backrest soft cushion arranged on the backrest frame 25. The sitting part includes a seat frame plate 21 and a seat soft cushion arranged on the seat frame plate 21. As shown in FIGS. 14 to 20, the follow-up assembly includes a follow-up plate 26. By the arrangement of the follow-up plate 26, the follow-up assembly is simple in structure, convenient to process and mount and easy to implement and has relatively low cost. A hinge point 1 D1 is formed at a hinge position between one end of the follow-up plate 26 and the front end of the backrest frame 25, and a hinge point 2 D2 is formed at the hinge position between the other end of the follow-up plate 26 and the seat frame plate 21. When the follow-up plate 26 swings about the hinge point 2 D2, the hinge point 1 D1 has the first position and the second position. A first limiting part 62 is arranged on the seat frame plate 21, and the first limiting part 62 is located on one side of the hinge point 2 D2 and is capable of being in limit fit with the follow-up plate 26. When the first limiting part 62 is in limit fit with the follow-up plate 26, the seat frame 20 is maintained in the zero gravity posture or the lying posture. When the first limiting part 62 is in limit fit with the follow-up plate 26, it limits the swing amplitude of the follow-up plate 26, thereby controlling the overall posture of the seat frame 20, preventing the excessive swing of the follow-up plate 26 when the seat frame 20 is in the zero gravity posture or the lying posture, and ensuring the safety and comfort of users in the zero gravity posture or the lying posture.

As shown in FIGS. 14 to 20, a side surface of the follow-up plate 26 has a first limiting plane, and the first limiting part 62 is a first limiting convex column. When the first limiting convex column is in limit fit with the first limiting plane, the seat frame 20 is maintained in the zero gravity posture or the lying posture. When the seat frame 20 is in the zero gravity posture or the lying posture, the relative position between the backrest frame 25 and the seat frame plate 21 is controlled by the limit fit between the first limiting convex column and the first limiting plane, thereby preventing the backrest frame 25 from swinging relative to the seat frame plate 21, ensuring the stability of the seat frame 20 maintained in the zero gravity posture or the lying posture, reducing the risk that the clothing is pulled out, and providing more comfortable and safer use experience.

As shown in FIGS. 14 to 20, the follow-up assembly further includes a transmission plate 27 located on the rear side of the follow-up plate 26 and spaced apart from the follow-up plate 26, the transmission plate 27 is hinged to the rear end of the backrest frame 25 and the seat frame plate 21, a hinge point 3 D3 is formed at the hinge position between the transmission plate 27 and the rear end of the backrest frame 25, a hinge point 4 D4 is formed at the hinge position between the transmission plate 27 and the seat frame plate 21, the third driving member 43 is connected with the transmission plate 27, and the third driving member 43 drives the backrest frame 25 to swing by the transmission plate 27. Wherein when the transmission plate 27 swings about the hinge point 4 D4, the hinge point 3 D3 has a third position and a fourth position, When the seat frame 20 is in the sitting posture or the TV posture, the hinge point 3 D3 is located at a third position. When the seat frame 20 is in the zero gravity posture, the hinge point 3 D3 is located at the fourth position, and the fourth position is located on the front side of the third position in the horizontal direction. In a process of switching the seat frame 20 between any two postures of the sitting posture, the TV posture, the zero gravity posture and the lying posture, the arrangement of the transmission plate 27 ensures that the backrest frame 25 can swing smoothly. During change from the sitting posture or the TV posture to the zero gravity posture or the lying posture, the change of the hinge point 3 D3 from the third position to the fourth position is accurately controlled, and then, the linkage between the backrest frame 25 and the follow-up plate 26 is more coordinated, thereby reducing the impact of the backrest frame 25 during posture change; and the position of the backrest frame in the lying posture moves a certain distance forward smoothly and reliably relative to the position of the backrest frame in the sitting posture, thereby improving the durability of the seat bracket and the comfort of the user. It should be noted that the positional change of the hinge point 3 D3 mentioned above is relative to the seat frame plate 21 and has no relation to the ground environment; the position of the hinge point 4 D4 is unchanged relative to the seat frame plate 21 and also has no relation to the ground environment.

Because the fourth position is located on the front side of the third position in the horizontal direction, the position of the backrest frame 25 in the lying posture moves a certain distance forward relative to the position of the backrest frame 25 in the sitting posture, so as to compensate for the distance of misaligned movement between the back of the user and the backrest part of the seat, thereby ensuring that the jacket always fits the backrest part while reducing the possibility of misalignment between the jacket and the backrest part.

As shown in FIGS. 14 to 20, the transmission plate 27 includes a transmission plate body 271 and an end connection plate 433 connected with the transmission plate body 271. The arrangement of the end connection plate 433 can improve the structural strength of the transmission plate body 271 to facilitate stable transmission of force during the process of the third driving member 43 driving the backrest frame 25 to swing by the transmission plate 27, thereby improving the stability of the swing of the backrest frame 25. The transmission plate body 271 is capable of being hinged to the seat frame plate 21, a second limiting part 63 is further arranged on the seat frame plate 21, the second limiting part 63 is located on one side of the hinge position between the transmission plate body 271 and the seat frame plate 21, and the second limiting part 63 can be in limit fit with the transmission plate body 271. When the second limiting part 63 is in limit fit with the transmission plate body 271, the seat frame 20 is maintained in the sitting posture or the TV posture. The second limiting part 63 indirectly limits the position of the backrest frame 25 by limiting the swing of the transmission plate body 271, so as to control the overall posture of the seat frame 20, thereby ensuring the stability of the seat frame 20 in the sitting posture or the TV posture, reducing the possibility of accidentally being in the zero gravity posture or the lying posture, and improving the safety and use experience.

As shown in FIGS. 14 to 20, a side surface of the transmission plate body 271 has a second limiting plane, and the second limiting part 63 is a second limiting convex column. When the second limiting convex column is in limit fit with the second limiting plane, the seat frame 20 is maintained in the sitting posture or the TV posture. By the direct contact between the second limiting convex column and the second limiting plane, the swing of the transmission plate body 271 can be effectively limited, thereby ensuring the stability of the seat frame 20 in the sitting posture or the TV posture, avoiding the accidental movement of the seat frame 20 when no posture change is required, and enhancing the reliability of the seat.

As shown in FIGS. 14 to 20, in order to facilitate the smooth swing of the backrest frame 25 and switching between a nearly upright state and a backward tilt state, the third driving member 43 includes a first moving structure 431 capable of being hinged to the front transverse rod 16 and a first driving rod 432 hinged to the first moving structure 431, and the first driving rod 432 is connected with the transmission plate 27. The first moving structure 431 includes a first moving member and a second moving member arranged in a relatively movable mode. When the second moving member moves relative to the first moving member, the first driving rod 432 is capable of swinging, so that the first driving rod 432 drives the backrest frame 25 to swing by the transmission plate 27.

The first moving member may be a cylinder. In this case, the second moving member is a piston rod, and the piston rod moves back and forth on the cylinder. The first moving member may also be a slide rail. In this case, the second moving member is a slide block, and the slide block moves back and forth on the slide rail.

In the present disclosure, the first driving rod 432 is fixedly connected with the end connection plate 433, the end connection plate 433 is fixedly connected with the transmission plate body 271, the transmission plate body 271 is hinged to the seat frame plate 21, and the hinge point 4 D4 is located between the hinge point 3 D3 and the fixed position of the first driving rod 432 and the end connection plate 433, so that the transmission plate 27 can achieve a lever effect.

In the present disclosure, the first driving member 41 has a telescopic rod 411, and the telescopic rod 411 of the first driving member 41, the first moving structure 431 of the third driving member 43 and the second moving structure 421 of the second driving member 42 are all electric push rods or slide block motors. The use of the electric push rod or the slide block motor enables the movement of the first moving structure 431, the telescopic rod 411 and the second moving structure 421 to be automatic, thereby reducing the difficulty of manual operation of users.

The present disclosure further provides a seat. An embodiment of the seat includes a seat bracket, and the seat bracket is the seat bracket mentioned above. In this way, because the seat bracket can solve the problem of lagging during a switching process of the seat frame in related technologies, leading to poor user comfort experience, the seat including the seat bracket can also solve the same technical problem.

The present disclosure further provides a seat. An embodiment of the seat includes a seat bracket, a backrest soft cushion, a seat soft cushion and a leg soft cushion. The seat bracket is the seat bracket mentioned above, the seat bracket further includes a footrest mechanism 50, the backrest soft cushion is mounted on a backrest frame 25, the seat soft cushion is mounted on a seat frame plate 21, and the leg soft cushion is mounted on the footrest mechanism 50. Because the above seat bracket can solve the problem that the jacket of the user is pulled out in related technologies, leading to poor experience, the seat including the seat bracket can also solve the same technical problem.

When the user uses the seat, comfortable body support is provided for users by the backrest soft cushion, the seat soft cushion and the leg soft cushion. The reasonable layout of the backrest soft cushion and the seat soft cushion ensures that the body contact surfaces of the user all remain soft and comfortable, thereby avoiding the discomfort that may be caused by hard components. The arrangement of the leg soft cushion allows the user to enjoy full body relaxation while maintaining good foot support, thereby improving the overall comfort of the seat.

In addition, it should be noted that using terms such as "first" and "second" to define parts is only intended to facilitate the differentiation of corresponding parts. Unless otherwise stated, the above terms have no special meanings and therefore cannot be understood as limiting the scope of protection of the present disclosure.

The above descriptions are merely preferred embodiments of the present disclosure, but are not intended to limit the present disclosure. For those skilled in the art, the present disclosure may have various modifications and changes. Any modification, equivalent replacement, improvement, and the like made within the spirit and principle of the present disclosure shall fall within the scope of protection of the present disclosure.

What is claimed is:

1. A seat bracket, comprising:
a chassis, comprising a base and a side plate swingably arranged on the base;
a seat frame, swingably arranged on the side plate and having a sitting posture, a TV posture and a zero gravity posture, the seat frame comprising a swingable seat frame plate;
a linkage mechanism, comprising a first linkage plate and a second linkage plate disposed at intervals, two ends of the first linkage plate being respectively hinged to the side plate and the seat frame plate, two ends of the second linkage plate being respectively hinged to the side plate and the seat frame plate, and the side plate, the first linkage plate, the second linkage plate and the seat frame plate at least enclosing a closed four-linkage structure; and
a first driving member, arranged on the base, when or after the first driving member operates, the seat frame plate swinging to drive the first linkage plate and the second linkage plate to swing to deform the four-linkage structure so that the seat frame is switched among the sitting posture, the TV posture and the zero gravity posture, wherein
in a process of switching the seat frame from the sitting posture or the TV posture to the zero gravity posture, the seat frame plate takes a zero gravity line as a reference line, a front end of the seat frame plate is adjusted to move towards the reference line, and a rear end of the seat frame plate is adjusted to move towards the reference line.

2. The seat bracket according to claim 1, wherein
the first linkage plate is located on a front side of the second linkage plate, a first end of the first linkage plate is hinged to a middle of the side plate, a first end of the second linkage plate is hinged to a rear end of the side plate, and a second end of the first linkage plate and a second end of the second linkage plate are both hinged to a part of the seat frame plate between the front end of the seat frame plate and the rear end of the seat frame plate; and/or
the front end of the seat frame plate moves upward towards the reference line by a first preset distance, the rear end of the seat frame plate moves downward towards the reference line by a second preset distance, and a difference between the first preset distance and the second preset distance is greater than or equal to 20 mm and less than or equal to 40 mm; and/or
the seat bracket further comprises a lifting plate, two ends of the lifting plate are respectively hinged to the seat frame plate and the first driving member, and the first driving member drives the seat frame plate to swing by the lifting plate; and/or
the chassis further comprises a front transverse rod fixedly connected with the side plate, the seat frame further has a lifting posture, the seat bracket further comprises a second driving member capable of being hinged to the front transverse rod, and the second driving member is capable of driving the seat frame plate to swing, so as to lift the seat frame to the lifting posture.

3. The seat bracket according to claim 1, wherein the seat frame further has a standing posture, the chassis further comprises a first support plate and a second support plate disposed at intervals, two ends of the first support plate are respectively hinged to the base and the side plate, two ends of the second support plate are respectively hinged to the base and the side plate, the first driving member is capable of driving the side plate to swing, and when the side plate swings, the first support plate and the second support plate are driven to swing so that the seat frame is switched between the sitting posture and the standing posture.

4. The seat bracket according to claim 3, wherein the side plate comprises a first plate body and a second plate body superposed left and right and arranged fixedly, two ends of the first support plate are respectively hinged to the base and the first plate body, two ends of the second support plate are respectively hinged to the base and the first plate body, two ends of the first linkage plate are respectively hinged to the second plate body and the seat frame plate, and two ends of the second linkage plate are respectively hinged to the second plate body and the seat frame plate.

5. The seat bracket according to claim 1, wherein
the seat frame further comprises a driving plate connected with the first driving member, a first driven plate hinged to the driving plate, and a second driven plate hinged to the first driven plate and the seat frame plate, the seat frame further comprises a footrest mechanism swingably arranged on the seat frame plate, and the linkage mechanism further comprises a third linkage plate hinged to the footrest mechanism and the second driven plate;
the chassis further comprises a front transverse rod fixedly connected with the side plate, the seat frame further has a lifting posture, the seat bracket further comprises a second driving member capable of being hinged to the front transverse rod, and the second driving member is capable of driving the seat frame plate to swing, so as to lift the seat frame to the lifting posture; and
when the first driving member drives the driving plate to swing, the driving plate drives the footrest mechanism to swing by the first driven plate, the second driven plate and the third linkage plate sequentially so that the seat frame is switched between the sitting posture and the TV posture, and in a case that the seat frame is in the TV posture, in a process of switching the seat frame to the lifting posture, a hinge position between the second driven plate and the first driven plate is a swing center of the seat frame plate.

6. The seat bracket according to claim 5, wherein the second driven plate is a triangular plate, a first hinge point is formed at the hinge position between the second driven plate and the first driven plate, a second hinge point is formed at a hinge position between the second driven plate and the seat frame plate, a third hinge point is formed at a hinge position between the second driven plate and the third linkage plate, and the first hinge point, the second hinge point and the third hinge point are respectively located on parts of three corners of the triangular plate.

7. The seat bracket according to claim 1, wherein
a limiting member is arranged on the side plate, and the limiting member is limited to the seat frame plate so that the seat frame is maintained in the sitting posture or the TV posture; and/or
the chassis further comprises a front transverse rod fixedly connected with the side plate, the seat frame further comprises a backrest frame hinged to the rear end of the seat frame plate, the seat bracket further comprises a third driving member capable of being hinged to the front transverse rod, the third driving member is capable of driving the backrest frame to swing, when or after the first driving member operates, the seat frame plate swings, and when the third driving member drives the backrest frame to swing, the seat frame is switched between two of the sitting posture, the TV posture and the zero gravity posture; and/or
the seat frame further comprises a footrest mechanism swingably arranged on the seat frame plate, and the linkage mechanism further comprises a third linkage plate hinged between the footrest mechanism and the first driving member;
the footrest mechanism comprises a pedal, a first front connection plate, a second front connection plate, a first rear connection plate and a second rear connection plate, the pedal and the seat frame plate are disposed at intervals, a first end of the first front connection plate is hinged to the pedal, a first end of the first rear connection plate is hinged to a second end of the first front connection plate, a second end of the first rear connection plate is hinged to the front end of the seat frame plate, a first end of the second front connection plate is hinged to the pedal, a first end of the second rear connection plate is hinged to a second end of the second front connection plate, a second end of the second rear connection plate is hinged to the seat frame plate, the second front connection plate is hinged to the first rear connection plate, and one end of the third linkage plate is hinged to the second rear connection plate; and
the first driving member comprises a telescopic rod hinged to the base and a driving rod hinged to the telescopic rod, the seat frame further comprises a driving plate fixedly connected with the driving rod, the side plate is hinged to the driving plate, when the telescopic rod extends or retracts, the driving rod is capable of being driven to swing so that the driving rod drives the driving plate to swing, when the driving plate swings, the side plate is driven to swing, or when the driving plate swings, the footrest mechanism is driven to fold or unfold.

8. The seat bracket according to claim 1, wherein when the seat frame is in the sitting posture or the TV posture or the zero gravity posture, the front end of the side plate abuts against the base.

9. The seat bracket according to claim 8, wherein a damping member capable of abutting against and cooperating with the front end of the side plate is arranged on the base.

10. The seat bracket according to claim 8, wherein the chassis further comprises a rear transverse rod fixedly connected with the side plate, and when the seat frame is in the sitting posture or the TV posture or the zero gravity posture, the rear transverse rod abuts against a middle of the base.

11. The seat bracket according to claim 10, wherein a support protrusion capable of abutting against and cooperating with the rear transverse rod is arranged in the middle of the base.

12. The seat bracket according to claim 8, wherein the front end of the seat frame plate moves upward towards the reference line by a first preset distance, the rear end of the seat frame plate moves downward towards the reference line by a second preset distance, a difference between the first preset distance and the second preset distance is greater than or equal to 20 mm and less than or equal to 40 mm, and the first preset distance is greater than or equal to 50 mm and less than or equal to 115 mm; and/or the second preset distance is greater than or equal to 20 mm and less than or equal to 85 mm.

13. The seat bracket according to claim 8, wherein the chassis further comprises a front transverse rod fixedly connected with the side plate, the seat frame further comprises a backrest frame hinged to the rear end of the seat frame plate, the seat bracket further comprises a third driving member capable of being hinged to the front transverse rod, the third driving member is capable of driving the backrest frame to swing, when or after the first driving member operates, the seat frame plate swings, and when the third driving member drives the backrest frame to swing, the seat frame is switched between two of the sitting posture, the TV posture and the zero gravity posture, wherein an angle of swing of the backrest frame relative to the seat frame plate is greater than or equal to 25° and less than or equal to 54°.

14. The seat bracket according to claim 1, wherein
the chassis further comprises a front transverse rod fixedly connected with the side plate;
the seat frame further has a lying posture, the seat frame further comprises a follow-up assembly and a backrest frame, two ends of the follow-up assembly are respectively hinged between the seat frame plate and the backrest frame, a hinge point 1 is formed at a hinge position between one end of the follow-up assembly and the backrest frame, and a hinge point 2 is formed at a hinge position between the other end of the follow-up assembly and the seat frame plate, the follow-up assembly is capable of swinging about the hinge point 2, so that the hinge point 1 has a first position and a second position;
the seat bracket further comprises a third driving member, the third driving member is capable of being hinged to the front transverse rod and connected with the follow-up assembly, the third driving member is capable of driving the backrest frame to swing by the follow-up assembly, and when the seat frame plate swings and the backrest frame swings, the seat frame is switched among the sitting posture, the TV posture, the zero gravity posture and the lying posture; and
when the seat frame is in the sitting posture or the TV posture, the hinge point 1 is located at the first position, and when the seat frame is in the zero gravity posture or the lying posture, the hinge point 1 is located at the second position, and the second position is located on a front side of the first position in a horizontal direction.

15. The seat bracket according to claim 14, wherein the follow-up assembly comprises a follow-up plate, the hinge point 1 is formed at a hinge position between one end of the follow-up plate and a front end of the backrest frame, the hinge point 2 is formed at a hinge position between the other end of the follow-up plate and the seat frame plate, when the follow-up plate swings about the hinge point 2, the hinge point 1 has the first position and the second position, a first limiting part is arranged on the seat frame plate, the first limiting part is located on a side of the hinge point 2 and is capable of being in limit fit with the follow-up plate, and when the first limiting part is in limit fit with the follow-up plate, the seat frame is maintained in the zero gravity posture or the lying posture.

16. The seat bracket according to claim 15, wherein
the follow-up assembly further comprises a transmission plate located on a rear side of the follow-up plate and spaced apart from the follow-up plate, the transmission plate is hinged to a rear end of the backrest frame and the seat frame plate, a hinge point 3 is formed at a hinge position between the transmission plate and a rear end of the backrest frame, a hinge point 4 is formed at a hinge position between the transmission plate and the seat frame plate, the third driving member is connected with the transmission plate, and the third driving member drives the backrest frame to swing by the transmission plate;
wherein when the transmission plate swings about the hinge point 4, the hinge point 3 has a third position and a fourth position, when the seat frame is in the sitting posture or the TV posture, the hinge point 3 is located at the third position, and when the seat frame is in the zero gravity posture or the lying posture, the hinge point 3 is located at the fourth position, and the fourth position is located on a front side of the third position in the horizontal direction.

17. The seat bracket according to claim 16, wherein
the transmission plate comprises a transmission plate body and an end connection plate connected with the transmission plate body, the transmission plate body is capable of being hinged to the seat frame plate, a second limiting part (63) is further arranged on the seat frame plate, the second limiting part is located on a side of a hinge position between the transmission plate body and the seat frame plate, the second limiting part is capable of being in limit fit with the transmission plate body, and when the second limiting part is in limit fit with the transmission plate body, the seat frame is maintained in the sitting posture or the TV posture; and/or
the third driving member comprises a first moving structure capable of being hinged to the front transverse rod and a first driving rod hinged to the first moving structure, the first driving rod is connected with the transmission plate, the first moving structure comprises a first moving member and a second moving member arranged in a relatively movable mode, and when the second moving member moves relative to the first moving member, the first driving rod is capable of being driven to swing so that the first driving rod drives the backrest frame to swing by the transmission plate.

18. The seat bracket according to claim 14, wherein
the first linkage plate is located on a front side of the second linkage plate, a first end of the first linkage plate is hinged to a middle of the side plate, a first end of the second linkage plate is hinged to the rear end of the side plate, and a second end of the first linkage plate and a second end of the second linkage plate are both hinged to part of the seat frame plate between the front end of the seat frame plate and the rear end of the seat frame plate; and/or
the first driving member comprises a telescopic rod hinged to the base and a driving rod hinged to the telescopic rod, the seat frame further comprises a driving plate fixedly connected with the driving rod and a footrest mechanism swingably arranged on the seat frame plate, the side plate is hinged to the driving plate, the telescopic rod is capable of driving the driving rod to swing so that the driving rod drives the driving plate to swing,
wherein when the driving plate swings, the side plate is driven to swing, or the driving plate is hinged to the footrest mechanism, when the driving plate swings, the footrest mechanism is driven to fold or unfold.

19. A seat, comprising a seat bracket, wherein the seat bracket is the seat bracket according to claim 1.

20. A seat, comprising a seat bracket, a backrest soft cushion, a seat soft cushion and a leg soft cushion, wherein the seat bracket is the seat bracket according to claim 14, the seat bracket further comprises a footrest mechanism, the backrest soft cushion is mounted on the backrest frame, the seat soft cushion is mounted on the seat frame plate, and the leg soft cushion is mounted on the footrest mechanism.
